(19) United States
(12) Patent Application Publication
(10) Pub. No.: US 2013/0189424 A1
(43) Pub. Date: Jul. 25, 2013

(54) HEATING APPARATUS, VACUUM-HEATING METHOD AND METHOD FOR MANUFACTURING THIN FILM

(71) Applicants: Sadayuki Okazaki, Osaka (JP); Kazuyoshi Honda, Osaka (JP)

(72) Inventors: Sadayuki Okazaki, Osaka (JP); Kazuyoshi Honda, Osaka (JP)

(21) Appl. No.: 13/820,141

(22) PCT Filed: Jun. 28, 2012
(86) PCT No.: PCT/JP2012/004212

§ 371 Date: Feb. 28, 2013

(30) Foreign Application Priority Data
Jun. 29, 2011 (JP) 2011-144561
Nov. 8, 2011 (JP) 2011-244664

(51) Int. Cl. H01M 10/04

(52) U.S. Cl. CPC H01M 10/04
USPC 427/58; 118/726

(57) ABSTRACT

Provided is a heating apparatus including: an object to be heated under vacuum; a heating body separable from the object to be heated, the heating body being configured so that a gap is formed between the heating body itself and the object to be heated; and a gas introduction channel for introducing a heat transfer gas into the gap. The object to be heated is heated by the heating body via the heat transfer gas. An example of the heating apparatus is a deposition apparatus 30. An example of the object to be heated is a storage container 9 that holds a deposition material and that has an opening for allowing the deposition material that has been vaporized to pass therethrough. An example of the heating body is a heating container 10 that detachably accommodates the storage container 9 and that has a heater 20 for heating the deposition material in the storage container 9. An example of the gas introduction channel is the gas introduction tube 11.

### TECHNICAL FIELD

The present invention relates to a heating apparatus, a vacuum heating method, and a thin film production method.

### BACKGROUND ART

In recent years, as mobile equipment comes to have high performance and multiple functions, capacity enhancement of secondary batteries, which serves as a power source for such equipment, has been required. Attention is now focused on non-aqueous electrolyte secondary batteries as a secondary battery that can satisfy this requirement. In order to increase the capacity of non-aqueous electrolyte secondary batteries, it has been proposed to use silicon (Si), germanium (Ge), tin (Sn), and the like, as an electrode active material (which is hereinafter referred to simply as an “active material”).

Si or Sn is used as an active material in the form of single silicon, silicon alloy, a compound containing silicon and oxygen, a compound containing silicon and nitrogen, single tin, tin alloy, a compound containing tin and oxygen, or a compound containing tin and nitrogen. However, these materials undergo expansion because their crystal structure significantly changes when they absorb lithium ions. As a result, active material particles crack, or an active material layer separates from a current collector. Thus, the electron conductivity between the active material and the current collector is reduced, resulting in a problem of decreasing the cycle characteristics.

Therefore, when using such a material as an active material, attempts have been made to reduce expansion and contraction of the active material.

Further, it is also known that these active materials containing Si or Sn have a problem of irreversible capacity. That is, when an active material containing Si or Sn is used as a negative electrode, some of lithium ions that have been absorbed during the initial electrical charge are not released from the negative electrode during electrical discharge, resulting in a problem of reduced battery capacity.

In order to avoid irreversible capacity, it is effective to prepare a negative electrode that has been allowed to absorb lithium beforehand in an amount equivalent to the irreversible capacity, and start charge/discharge by having the negative electrode face a positive electrode. Patent Literature 1 discloses a method of applying lithium onto an active material layer formed on a surface of a current collector by vacuum deposition.

The vacuum deposition technique is applied, for example, to the production of organic EL displays, other than to secondary batteries.

Embodiments as disclosed in Patent Literatures 2 to 4 have been proposed as a vaporization source for vacuum deposition.

Patent Literature 2 discloses a vaporization source including a storage section for material to be vaporized, a nozzle section that is coupled to the storage section and injects the material to be vaporized, and a heating section that surrounds the storage section, as a vaporization source for deposition of a low-molecular organic material capable of vaporizing at a comparatively low temperature of 200 to 400° C.

Patent Literature 3 discloses a vaporization source in which an indirect heater is arranged in contact with the bottom of a crucible, as a vaporization source of metals such as aluminium, copper, silver, and zinc. This vaporization source is used in the case where the vaporization temperature is as high as 1000° C. or more.

Patent Literature 4 discloses a crucible including a box-shaped inner lining for holding molten metal at high temperature, a crucible body, and a spacer interposed between the inner lining and the crucible body, in which the space between the inner lining and the crucible body is filled with a liquid heat medium. This crucible is used in the case of directly heating and melting a deposition material using electron gun, or the like.

### CITATION LIST

Patent Literature
Patent Literature 1: JP 2007-128658 A
Patent Literature 2: JP 4557170 B2
Patent Literature 3: JP 8 (1996)-311638 A
Patent Literature 4: JP 2 (1990)-93063 A

### SUMMARY OF INVENTION

### Technical Problem

For depositing a material under vacuum or heating a substrate under vacuum, a heating apparatus that can be used under vacuum is necessary. Since a gas that serves as a medium is thin under vacuum, it is not easy to heat a substance efficiently under vacuum. For example, when a heater (heating body) is integrated with a crucible (object to be heated), it might be possible to improve the heat transfer efficiency from the heating body to the object to be heated due to their direct contact. However, excessive focus on the heat transfer efficiency increases the possibility of deteriorating the maintenance property.

In view of the above-mentioned circumstances, it is an object of the present invention to provide a heating apparatus that allows easy maintenance as well as efficient heating of a substance under vacuum.

### Solution to Problem

That is, the present disclosure provides a heating apparatus including: an object to be heated under vacuum; a heating body separable from the object to be heated, the heating body being configured so that a gap is formed between the heating body itself and the object to be heated; and a gas introduction channel for introducing a heat transfer gas into the gap, in which the object to be heated is heated by the heating body via the heat transfer gas.

### Advantageous Effects of Invention

According to the above-mentioned heating apparatus, the heating body is separable from the object to be heated. Accordingly, their maintenance can be performed easily. The gap is formed between the object to be heated and the heating body. The heat transfer gas is introduced into the gap through the gas introduction channel. The object to be heated is heated by the heating body via the heat transfer gas. Accordingly, the object to be heated such as a crucible can be efficiently heated.

### BRIEF DESCRIPTION OF DRAWINGS

FIG. 1 is a sectional view schematically showing a deposition apparatus according to Embodiment 1 of the present invention.

FIG. 2 is an enlarged partial view showing the vicinity of a vaporization source in the deposition apparatus of FIG. 1.

FIG. 3 is an enlarged partial view showing the vicinity of a vaporization source that can be applied to the deposition apparatus of FIG. 1.

FIG. 4 is an enlarged partial view showing the vicinity of a vaporization source that can be applied to the deposition apparatus of FIG. 1.

FIG. 5 is an enlarged partial view showing the vicinity of a vaporization source that can be applied to the deposition apparatus of FIG. 1.

FIG. 6 is an enlarged partial view showing the vicinity of a vaporization source as a reference example.

FIG. 7 is a sectional view schematically showing a deposition apparatus according to Embodiment 2 of the present invention.

FIG. 8 is an enlarged partial view showing the vicinity of a vaporization source that can be applied to the deposition apparatus of FIG. 7.

FIG. 9 is an enlarged partial view showing the vicinity of a vaporization source in the deposition apparatus of FIG. 7.

FIG. 10 is an enlarged partial view showing the vicinity of a vaporization source that can be applied to the deposition apparatus of FIG. 1.

FIG. 11 is an enlarged partial view showing the vicinity of a vaporization source that can be applied to the deposition apparatus of FIG. 1.

FIG. 12A is an enlarged partial view showing the vicinity of a vaporization source that can be applied to the deposition apparatus of FIG. 1.

FIG. 12B is a bottom view of a lid 69 in FIG. 12A.

FIG. 13A is an enlarged partial view showing the vicinity of a vaporization source that can be applied to the deposition apparatus of FIG. 1.

FIG. 13B is a bottom view of a lid 69 in FIG. 13A.

FIG. 14 is an enlarged partial view showing the vicinity of a vaporization source that can be applied to the deposition apparatus of FIG. 1.

FIG. 15 is an enlarged partial view showing the vicinity of a vaporization source that can be applied to the deposition apparatus of FIG. 1.

FIG. 16A is a graph showing the results of temperature rise over time in the case where no gas is introduced into the gap between a heating container and a storage container (comparative test example).

FIG. 16B is a graph showing the results of temperature rise over time (time up to about 1800 seconds) in the case where a gas is introduced into the gap between the heating container and the storage container (test example).

FIG. 16C is a graph showing the results of temperature rise over time (time up to 9600 seconds) in the case where the gas is introduced into the gap between the heating container and the storage container (test example).

FIG. 17 is a schematic diagram of a vacuum deposition apparatus provided with a vaporization source (heating apparatus) according to Embodiment 3 of the present invention.

FIG. 18 is a perspective view of the vaporization source (heating apparatus) shown in FIG. 17.

FIG. 19 is a front view of the vaporization source.

FIG. 20 is a sectional view of the vaporization source taken along the line A-A.

FIG. 21 is a sectional view of a heater.

FIG. 22 is a sectional view of a vaporization source according to Modification 1.

FIG. 23 is a sectional view of a vaporization source according to Modification 2.

FIG. 24A is a perspective view of a cylindrical component that can be used for the vaporization source shown in FIG. 23.

FIG. 24B is a perspective view of a gutter-shaped component that can be used for the vaporization source shown in FIG. 23.

FIG. 25 is a sectional view of a vaporization source according to Modification 3.

FIG. 26 is a perspective view of a substrate heating apparatus according to Embodiment 4 of the present invention.

### DESCRIPTION OF EMBODIMENTS

A first aspect of the present disclosure provides a heating apparatus including: an object to be heated under vacuum; a heating body separable from the object to be heated, the heating body being configured so that a gap is formed between the heating body itself and the object to be heated; and a gas introduction channel for introducing a heat transfer gas into the gap, in which the object to be heated is heated by the heating body via the heat transfer gas.

The heating apparatus of the first aspect may be configured as a deposition apparatus. The inventors have found the following problems in conventional deposition apparatuses. The following problems can be solved by applying the heating apparatus of the first aspect to the deposition apparatuses.

Conventionally, when forming a deposition film on a substrate surface using a roll-to-roll deposition apparatus, a nozzle-type vaporization source as disclosed in Patent Literature 2 has been used. In the case of using, as a deposition material in this vaporization source, a material with a high boiling point such as metals, the deposition material needs to be heated to 600° C. or more. However, the heating temperature of the heater needs to be set to 1000° C. or more because the thermal conductivity between the vaporization source and the heater is reduced under vacuum. Generally, the maximum use temperature of cartridge heaters is 870° C., and the maximum use temperature of ceramic heaters is 1100° C. Therefore, when heating to 1000° C. or more is performed using these heaters, the temperature control of the heaters is made impossible. Thus, these heaters have been extremely difficult to use.

In the vaporization source according to Patent Literature 3, the area in contact with an indirect heater is limited to the bottom surface of the crucible, and thus there is a problem that deposition is made impossible due to insufficient heat capacity, for example, when the deposition material in the crucible is increased with an increase in the deposition area.

In the vaporization source according to Patent Literature 4, for the purpose of improving durability and utilizing thermal energy generated when the deposition material is heated, a liquid heat medium is filled between the crucible and the inner lining. However, when the deposition material is heated from outside by such means as an electron gun, the liquid heat medium is vaporized under vacuum, thus resulting in a problem of loss of intended heat conduction effect.

The inventors have considered to perform deposition by directly attaching a cartridge heater, as a heater, to the outer surface of a crucible so as to heat several hundred grams of a deposition material held in the crucible. In this deposition, the heating temperature of the container is set by estimating the vaporization temperature under vacuum from the vapor pressure line of the deposition material. As a result, although a deposition film can be formed on a substrate, it is necessary to detach the cartridge heater from the crucible beforehand when maintenance is performed, for example, to remove the deposition material that has been left in the crucible after the completion of the deposition. Particularly, when the substrate has a large width and the deposition material to be held increases, the volume of the crucible correspondingly increases as well. Accordingly, the number of cartridge heaters also increases, making the maintenance extremely complicated, which also is a problem.

In order to avoid the problem of complicated maintenance, the inventors have considered to perform deposition by accommodating a crucible in a heating container having a heater, not directly attaching the heater to the crucible. According to this method, the maintenance work after the completion of deposition is facilitated. However, there is still a problem that the temperature of the deposition material is not sufficiently increased in the range of the aforementioned use temperature of the heater, because the thermal conductivity between the heating container and the crucible is reduced under vacuum, resulting in failure of deposition, or even if deposition were possible, deposition becomes uncontrollable when the deposition is performed continuously for a long period of time.

According to the second aspect of the present disclosure, there is provided, in addition to the first aspect, a heating apparatus in which: the object to be heated is a storage container that holds a deposition material and that has an opening for allowing the deposition material that has been vaporized to pass therethrough, the heating body is a heating container that detachably accommodates the storage container and that has a heater for heating the deposition material in the storage container, the heating container further having an opening for allowing the deposition material that has been vaporized from the storage container to pass therethrough, the heating container being configured, when accommodating the storage container, so that an inner wall surface of the heating container and an outer wall surface of the storage container directly face each other so as to form the gap between the inner wall surface and the outer wall surface, and the heating apparatus is a deposition apparatus and further includes: (i) a vacuum chamber in which the storage container and the heating container are enclosed and deposition on a substrate is performed, and (ii) a vacuum pump that evacuates the vacuum chamber.

In other words, the second aspect provides a deposition apparatus including: a storage container that holds a deposition material and that has an opening for allowing the deposition material that has been vaporized to pass therethrough; a heating container that detachably accommodates the storage container and that has a heater for heating the deposition material in the storage container, the heating container further having an opening for allowing the deposition material that has been vaporized from the storage container to pass therethrough, the heating container being configured, when accommodating the storage container, so that an inner wall surface of the heating container and an outer wall surface of the storage container directly face each other so as to form the gap between the inner wall surface and the outer wall surface; a vacuum chamber in which the storage container and the heating container are enclosed and deposition on a substrate is performed; and a vacuum pump that evacuates the vacuum chamber.

According to the second aspect, the storage container that holds the deposition material is accommodated in the heating container, and the gap is configured to be formed between the two containers. Therefore, when maintenance such as replacement of the storage container and removal of residual deposition material inside the storage container is performed after the completion of deposition, the storage container and the heating container can be easily separated from each other. Thus, the need for complicated work such as detachment of the heater from the storage container is eliminated and the maintenance work can be facilitated.

Also, introduction of the heat transfer gas into the gap enables heat from the heating container to be efficiently transferred to the storage container during vacuum deposition, so that the deposition material is heated. Therefore, the temperature of the deposition material can be sufficiently increased despite indirect heating, and thus deposition can be controlled to be stable continuously for a long period of time.

As seen from above, the second aspect allows not only efficient and continuous deposition under vacuum but also dramatically simplified maintenance work after the completion of deposition. Thus, deposition can be performed with extremely excellent productivity.

Use of the above-mentioned deposition apparatus, for example, enables an electrode having excellent charge/discharge cycle characteristics to be produced with excellent productivity.

According to the third aspect of the present disclosure, there is provided, in addition to the second aspect, a heating apparatus in which the gap has a width of 0.5 mm or less. According to the third aspect, the gas pressure in the gap can be increased with a small gas introduction amount.

According to the fourth aspect of the present disclosure, there is provided, in addition to the second or the third aspect, a heating apparatus further including a suppression structure that suppresses the heat transfer gas from flowing out of the gap into the vacuum chamber. According to the fourth aspect, the pressure in the gap can be increased with a small gas introduction amount. Also, a reduction in the degree of vacuum inside the vacuum chamber due to introduction of the gas into the gap can be avoided.

According to the fifth aspect of the present disclosure, there is provided, in addition to the fourth aspect, a heating apparatus in which the suppression structure is configured to change a flow direction of the heat transfer gas flowing out of the gap, or is configured to reduce an amount of heat transfer gas flowing out of the gap. According to the fifth aspect, the pressure in the gap can be increased with a small gas introduction amount. Also, a reduction in the degree of vacuum inside the vacuum chamber due to introduction of the gas into the gap can be avoided.

According to the sixth aspect of the present disclosure, there is provided, in addition to the fourth or the fifth aspect, a heating apparatus in which the suppression structure is a step structure or a tapered structure provided around the opening of the storage container and the opening of the heating container. The sixth aspect allows accurate positioning to be performed when the storage container is accommodated into the heating container, so that the formation of a specific gap is ensured on the side surface and the bottom surface of the storage container. Also, when the storage container is supported by the step structure or the tapered structure, the gap is closed at the openings of the storage container and the heating container, so that it can be an isolated space from the vacuum chamber. In this case, the pressure in the gap can be increased with a small gas introduction amount.

According to the seventh aspect of the present disclosure, there is provided, in addition to the sixth aspect, a heating apparatus in which the gap around the opening of the storage container and the opening of the heating container is narrower than the gap other than around the openings by providing the step structure or the tapered structure. According to the seventh aspect, the gas introduced into the gap is suppressed from diffusing into the vacuum chamber so that the pressure in the gap can be increased with a small gas introduction amount.

According to the eighth aspect of the present disclosure, there is provided, in addition to any one of the second to the seventh aspects, a heating apparatus in which a thermal expansion coefficient of the heating container is smaller than a thermal expansion coefficient of the storage container. According to the eighth aspect, an increase in the temperature of the heater in the heating container causes the gap between the heating container and the storage container to decrease, which increases the gas pressure in the gap, leading to an increase in the thermal conductivity coefficient. As a result, heat efficiency can be enhanced.

According to the ninth aspect of the present disclosure, there is provided, in addition to any one of the second to the eighth aspects, a heating apparatus further including a through passage for allowing the heat transfer gas to pass therethrough. The through passage is provided between a space accommodating the heater inside the heating container and an inner wall surface of the heating container. According to the ninth aspect, heat from the heater is more efficiently transferred to the storage container, and thus the heating amount of the heater can be reduced.

According to the tenth aspect of the present disclosure, there is provided, in addition to any one of the second to the ninth aspects, a heating apparatus in which the gap is closed at the opening of the storage container and the opening of the heating container. According to the tenth aspect, the pressure in the gap can be increased with a small gas introduction amount. Also, a reduction in the degree of vacuum (increase in pressure) inside the vacuum chamber due to introduction of the gas into the gap can be avoided.

According to the eleventh aspect of the present disclosure, there is provided, in addition to any one of the second to the tenth aspects, a heating apparatus in which a lid is placed over an opening of the gap. According to the eleventh aspect, the existence of the lid suppresses the gas from diffusing into the vacuum chamber, so that the pressure in the gap can be increased with a small gas introduction amount.

According to the twelfth aspect of the present disclosure, there is provided, in addition to the eleventh aspect, a heating apparatus in which a gas flow passage that allows the heat transfer gas that has been introduced into the gap to pass therethrough is formed on the lower surface of the lid. According to the twelfth aspect, the gas introduced into the gap can be discharged into the vacuum chamber at a point away from the opening of the storage container. Accordingly, it is possible to avoid causing adverse effects on deposition such as that the gas introduced into the gap leaks in the direction of the opening of the storage container to collide with the deposition material that is being vaporized from the storage container, resulting in deterioration in film properties (e.g., the adhesion strength to the substrate is weakened, or the film is made porous).

According to the thirteenth aspect of the present disclosure, there is provided a thin film production method being a deposition method for deposition on a substrate under vacuum using a deposition apparatus including: a storage container that holds a deposition material and that has an opening for allowing the deposition material that has been vaporized to pass therethrough; a heating container that detachably accommodates the storage container and that has a heater for heating the deposition material in the storage container, the heating container further having an opening for allowing the deposition material that has been vaporized from the storage container to pass therethrough, the heating container being configured, when accommodating the storage container, so that an inner wall surface of the heating container and an outer wall surface of the storage container directly face each other so as to form a gap between the inner wall surface and the outer wall surface; a gas introducing means for introducing a heat transfer gas into the gap; a vacuum chamber in which the storage container and the heating container are enclosed and deposition on a substrate is performed; and a vacuum pump that evacuates the vacuum chamber, the thin film production method including the step of vaporizing the deposition material from the storage container by heating the deposition material in the storage container using the heater, while introducing the heat transfer gas into the gap.

The thirteenth aspect allows not only efficient and continuous deposition under vacuum but also dramatically simplified maintenance work after the completion of deposition. Thus, deposition can be performed with extremely excellent productivity.

According to the fourteenth aspect of the present disclosure, there is provided, in addition to the thirteenth aspect, a thin film production method in which an introduction amount of the heat transfer gas is controlled according to the pressure in the vacuum chamber. It is possible to suppress variation in the vaporization rate of the deposition material by appropriately controlling the gas introduction amount.

According to the fifteenth aspect of the present disclosure, there is provided, in addition to the thirteenth or the fourteenth aspect, a thin film production method in which the deposition material is lithium, and the heat transfer gas is an inert gas.

According to the fifteenth aspect, lithium can be prevented from reacting with the heat transfer gas and a lithium thin film of high quality can be formed on the substrate.

In addition, the inventors disclose the following.

As a vacuum heating apparatus, it is conceivable to use a heating apparatus provided with a rod-shaped heater, and a heating block having a slot into which the heater is inserted. Since sufficient heat conduction is difficult to achieve under vacuum, the heater is effectively brought into close contact with the slot.

However, in the case where the outer diameter of the heater is almost the same as the inner diameter of the slot, it is made impossible to pull the heater out of the heating block at the time of maintenance of the heater or replacement of the heater. Particularly in the case of using a long heater, a long slot needs to be formed within the heating block. It is difficult to form a long slot with high accuracy. On the other hand, when the gap between the heater and the slot is excessively wide, heat conduction from the heater to the heating block falls short, resulting in deterioration in temperature rise characteristics of the heating block. In this case, not only the energy efficiency (power efficiency) is reduced, but also the life of the heater is shortened, because of the necessity to increase the temperature of the heater.

According to the sixteenth aspect of the present disclosure, there is provided, in addition to the first aspect, a heating apparatus in which the object to be heated is a heating block that heats a substance under vacuum, the heating body is a rod-shaped heater that is detachably inserted into a slot formed within the heating block, the gap is formed between the slot and the heater, and the gas introduction channel is formed within the heating block so as to introduce the heat transfer gas into the gap.

In other words, the sixteenth aspect provides a heating apparatus including: a heating block that heats a substance under vacuum; a slot formed within the heating block; a rod-shaped heater that is detachably inserted into the slot; and a gas introduction channel that is formed within the heating block and that introduces a heat transfer gas into a gap between the slot and the heater.

According to the sixteenth aspect of the present disclosure, the gas introduction channel is formed within the heating block. Through the gas introduction channel, the heat transfer gas is introduced into the gap between the heater and the slot. The heat transfer gas helps to promote the heat transfer from the heater to the heating block, and thus the difference between the temperature of the heater and the temperature of the heating block can be reduced. That is, it is possible to improve the temperature rise characteristics of the heating block while appropriately ensuring the gap between the heater and the slot. Since the gap between the heater and the slot can be appropriately ensured, the heater can be easily pulled out of the slot at the time of maintenance or replacement. In this way, the present disclosure can provide a heating apparatus that is excellent in energy efficiency and allows easy maintenance. Also, the life of the heater is extended because there is no need for excessively increasing the temperature of the heater.

According to the seventeenth aspect of the present disclosure, there is provided, in addition to the sixteenth aspect, a heating apparatus in which a plurality of the slots are formed within the heating block, the heater is inserted into each of the plurality of slots, and the gas introduction channel includes a first channel that introduces the heat transfer gas from outside the heating block into the slot and a second channel that allows the slots to communicate with each other. According to such a configuration, the heat transfer from the heaters to the heating block can be promoted with a small amount of the heat transfer gas.

According to the eighteenth aspect of the present disclosure, there is provided, in addition to the sixteenth or the seventeenth aspect, a heating apparatus in which the gap is relatively wide in a center portion of the slot in a length direction, and the gap is relatively narrow in an end portion of the slot in the length direction. According to the eighteenth aspect, since the gap is relatively narrow in the end portion of the slot, leakage of the heat transfer gas from the gap can be reduced. Further, the gap is relatively wide in the center portion of the slot, and therefore the heater can be easily inserted into the slot, as well as the heater can be easily pulled out of the slot.

According to the nineteenth aspect of the present disclosure, there is provided, in addition to any one of the sixteenth to the eighteenth aspects, a heating apparatus in which the heater has: a heater main body that has a heating element; and a lead wire that is electrically connected to the heating element of the heater main body so as to supply power to the heating element, and the slot is closed on a side opposite to a side where the lead wire is located. By closing the slot, it is possible to reduce the amount of the heat transfer gas that leaks from the gap into the vacuum chamber. A flange also brings about the same effect as is the case where the slot is formed of a bottomed hole.

According to the twentieth aspect of the present disclosure, there is provided, in addition to any one of the sixteenth to the nineteenth aspects, a heating apparatus in which a size of the heater and a size of the slot are adjusted so as to allow motion of the heater during energization. With such a configuration, application of a large force (load or stress) to the heater can be prevented from being caused by thermal expansion during energization. Therefore, the life of the heater is extended.

According to the twenty-first aspect of the present disclosure, there is provided, in addition to any one of the sixteenth to the twentieth aspects, a heating apparatus in which the heater has: a heater main body that has a heating element; a lead section that has a lead wire for supplying power to the heating element; and a connecting section provided between the lead section and the heater main body so as to electrically connect the lead wire to the heating element, and the connecting section is located outside the slot. This can extend the life of the heater.

According to the twenty-second aspect of the present disclosure, there is provided, in addition to any one of the sixteenth to the twenty-first aspects, a heating apparatus in which the heating apparatus is a vaporization source, and the heating block is a vaporization container having a concave portion that holds the substance as a material to be vaporized. The heater heats the heating block, thereby causing the material held in the concave portion to be melted and vaporized.

According to the twenty-third aspect of the present disclosure, there is provided, in addition to any one of the sixteenth to the twenty-first aspects, a heating apparatus in which the heating apparatus is a substrate heating apparatus that heats a substrate. According to the twenty-third aspect, the substrate can be efficiently heated.

According to the twenty-fourth aspect of the present disclosure, there is provided a vacuum heating method including the steps of heating the substance under vacuum using the heating apparatus according to any one of the sixteenth to the twenty-third aspects; and supplying the heat transfer gas from outside vacuum to the heating apparatus while performing the heating step. According to the twenty-fourth aspect, the substance can be efficiently heated under vacuum.

According to the twenty-fifth aspect of the present disclosure, there is provided a thin film production method including the steps of vaporizing a material of a thin film as the substance under vacuum using the heating apparatus according to any one of the sixteenth to the twenty-second aspects and depositing the vaporized material on a substrate; and supplying the heat transfer gas from outside vacuum to the heating apparatus while performing the deposition step. The twenty-fifth aspect allows thin films of high quality to be produced efficiently.

Hereinafter, embodiments of the present invention are described with reference to drawings. It should be noted that the present invention is not limited by the following embodiments.

### Embodiment 1

Embodiment 1 is an embodiment in which deposition is performed within a deposition region on a cooling can while a substrate in the form of a sheet is conveyed in a chamber.

### Configuration of Deposition Apparatus

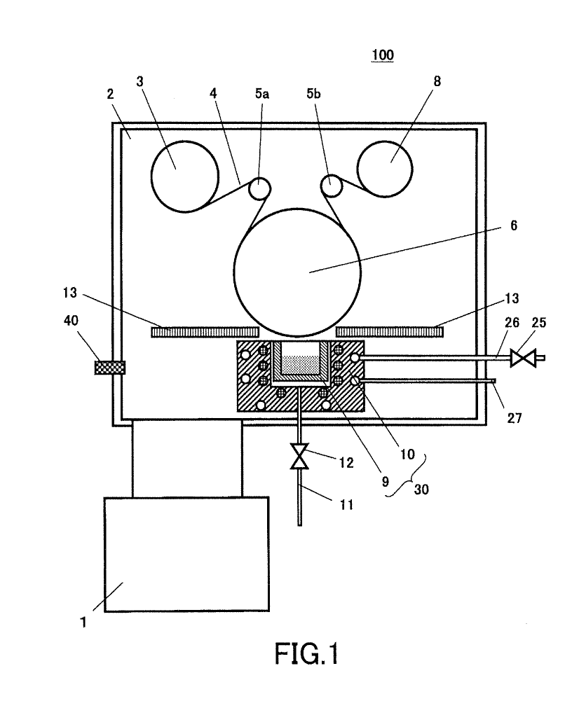

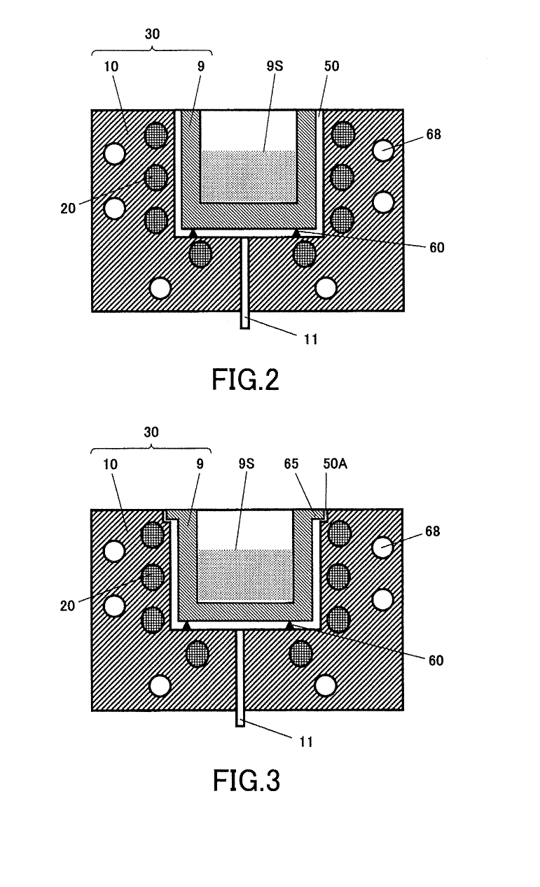

FIG. 1 is a sectional view schematically showing a deposition apparatus of Embodiment 1, and FIG. 2 is an enlarged partial view showing the vicinity of a vaporization source in the deposition apparatus of FIG. 1.

A deposition apparatus 100 is provided with a chamber (vacuum chamber) 2, an evacuation pump 1 provided outside the chamber 2 so as to evacuate the chamber 2, a gas introduction tube 11 (gas introduction channel) that introduces a gas (heat transfer gas) such as an inert gas from outside the chamber 2 into the chamber 2, and a mass flow controller 12 that regulates the gas flow rate through the gas introduction tube 11.

The chamber 2 is internally provided with a vaporization source 30 having a storage container 9 (object to be heated) that holds a deposition material and a heating container 10 (heating body) that detachably accommodates the storage container 9 so as to heat the storage container 9, a conveying section for conveying a substrate 4 in the form of a sheet, a cooling can 6 that carries the substrate 4 and cools it from the back side in a deposition region, and a shielding section 13 for shielding radiant heat of the heating container 10 outside the deposition region.

The storage container 9 has a concave portion that holds a deposition material, and an opening, on its upper end surface, that allows a gas of the deposition material that has been heated and vaporized by the heating container 10 to pass therethrough. A material that is not reactive with the deposition material during heating and vaporization is selected as the constituent material for the storage container 9. In this embodiment, no heating means is provided in the storage container 9.

The storage container 9 is arranged so that the long side of a vaporization surface 9S is parallel to the width direction of the substrate 4. The storage container 9 may be configured so that the long side of the vaporization surface 9S has a sufficient length (for example, 600 mm or more, when the width of the substrate 4 is 500 mm) with respect to the width of the substrate 4.

The cooling can 6 and the opening of the storage container 9 are arranged as close as possible to each other within a range such that the substrate 4 when being conveyed is kept from contact with these members. Specifically, they can be arranged so that a gap, for example, of about 3 mm is formed therebetween. This can prevent unintended deposition onto members other than the substrate 4 in the chamber 2.

The heating container 10 is a container that accommodates the storage container 9 by surrounding surfaces of the storage container 9 except one that has the opening. The heating container 10, when accommodating the storage container 9, has an opening in the same direction as the direction of the opening of the storage container 9. The gas of the deposition material that has been vaporized passes through the opening of the heating container 10 to deposit on the surface of the substrate. Further, through the opening of the heating container 10, the storage container 9 is attached to the heating container 10 and the storage container 9 is detached from the heating container 10. Therefore, the opening of the heating container 10 has a size enough to allow the storage container 9 to pass therethrough. However, it is also possible, for example, to design the heating container 10 to have a structure capable of being divided, so that the storage container 9 can be detached by dividing the heating container 10. In this case, the opening of the heating container 10 does not necessarily allow the storage container 9 to pass therethrough.

In FIG. 2, the upper end surface of the heating container 10 in the vertical direction and the upper end surface of the storage container 9 in the vertical direction are configured to be on a single plane so that just the right amount of heat is transferred from the heating container 10 to the storage container 9, which is, however, not necessarily restrictive.

As a constituent material for the heating container 10, one selected from a material that is the same as the constituent material of the storage container 9 and a material that has a lower thermal expansion coefficient than the constituent material of the storage container 9 is desired. Particularly, a material that has a lower thermal expansion coefficient than the constituent material of the storage container 9 is desirably used as the constituent material of the heating container 10. This allows the gap between the heating container 10 and the storage container 9 to decrease with a temperature rise of the heater integrated in the heating container 10, which increases the gas pressure in the gap, leading an increase in the thermal conductivity coefficient. As a result, heat efficiency can be enhanced. Examples of a combination of constituent materials with different thermal expansion coefficients include a combination of SUS304 (1.73×10⁻⁵/° C.) and inconel (1.15×10⁻⁵/° C.); and a combination of SUS304 or SUS430 (1.04×10⁵/° C.) and carbon (0.5×10⁵/° C.) or metals with a high melting point such as Mo (0.49×10⁻⁵/° C.), tungsten (0.51×10⁵/° C.), tantalum (0.65×10⁵/° C.), and niobium (0.7×10⁻⁵/° C.). It should be noted that all these thermal expansion coefficients are an average thermal expansion coefficient in the range of 0 to 100° C. Strictly speaking, attention should be focused on an average thermal expansion coefficient in the range from room temperature to the maximum peak temperature of the heating container 10. However, except some special cases, the relative relation of average thermal expansion coefficient between two solids in the range of 0 to 100° C. matches the relative relation of average thermal expansion coefficient between two solids in the range from room temperature to the maximum peak temperature of the heating container 10.

In the constituent material of the heating container 10, a heater 20 for heating the deposition material is embedded. By this heater 20, the deposition material held in the storage container 9 can be heated. Generally, cartridge heaters (maximum use temperature: 870° C.) or ceramic heaters (maximum use temperature: 1100° C.) can be used as the heater 20.

As a method for embedding the heater 20 into the heating container 10, a method in which the heating container 10 is first subjected to drilling with a fit tolerance of about E8 with respect to the outer diameter of a cartridge heater and then the cartridge heater is inserted thereinto, followed by securing the heater by inserting a screw through a tap hole processed perpendicularly to the drill hole, or followed by securing the heater by allowing the heating container 10 to have a divided structure with the drill hole at a center and interposing the heater therebetween, for example, can be employed. The “fit tolerance” is defined in Japan industrial standard JIS B0401 (1999).

An air-cooling passage 68 that allows air to pass therethrough is desirably provided within the heating container 10. After the completion of deposition, compressed air is introduced from outside the chamber 2 into the air-cooling passage 68. The thus introduced compressed air passes through the inside of the heating container 10 and is then discharged to the outside of the chamber 2. This allows the vaporization source 30 to be rapidly cooled after the completion of vaporization.

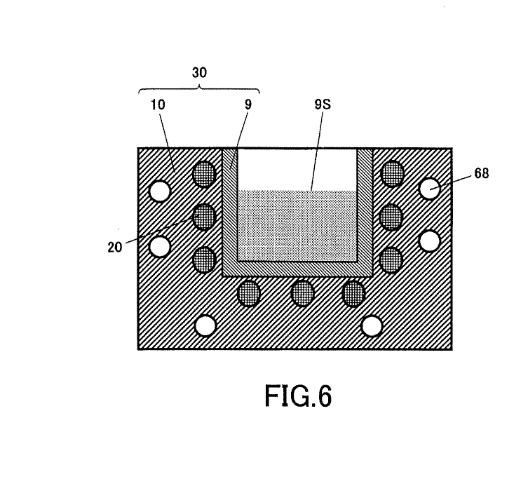

The heating container 10 is formed to have a size such that a gap 50 is formed between the inner wall surface of the heating container 10 and the outer wall surface of the storage container 9, when the storage container 9 is accommodated therein. The gap 50 is formed by the outer peripheral surface of the storage container 9 and the inner wall surface of the heating container 10 directly facing each other. In this embodiment, the gap 50 is a single layer gap. In the reference example shown in FIG. 6, the outer wall surface of the storage container 9 and the inner wall surface of the heating container 10 are in contact with each other. Although this case is desired in view of heat conduction, detachment of the storage container 9 from the heating container 10 is made difficult due to friction. Further, it is concerned that separation of the two containers from each other might be made difficult due to seizure. In this embodiment, the existence of the gap 50 between the two containers eliminates the concern about seizure and allows easy detachment, and thus can facilitate maintenance work after the completion of deposition.

On the other hand, in the case where the gap 50 is merely provided, heat from the heating container 10 is difficult to transfer to the storage container 9 because of difficult heat conduction under vacuum, which makes it impossible to perform well controlled deposition. In order to overcome this point, the gas pressure in the gap 50 is increased by introducing a gas through the gas introduction tube 11 into the gap 50 in this embodiment. The existence of the gas in the gap 50 facilitates heat conduction, so that heat from the heating container 10 is transferred to the storage container 9, which enables deposition. Specifically, in the case where no gas is introduced into the gap 50, the heat transfer coefficient from the heating container 10 to the storage container 9 under a vacuum of 0.1 Pa or less is 0.002 W/cm²/K, while in the case where the gas is introduced, the heat transfer coefficient increases, when the gas pressure in the gap 50 is 50 Pa or more. For example, the heat transfer coefficient is 0.01 W/cm²/K, when the gas pressure in the gap 50 is 100 Pa.

For increasing the gas pressure in the gap 50 with a small gas introduction amount, the gap 50 desirably has a dimension of 1.0 mm or less. That is, the internal dimension of the concave portion of the heating container 10 is desirably larger than the external dimension of the storage container 9 by 1.0 mm or less. There is gap dependency in heat transfer coefficient at the same pressure under vacuum. For example, when the gas pressure in the gap is 100 Pa and the gap width is 0.5 mm, the heat transfer coefficient is 0.007 W/cm²/K. However, when the gap is larger than this, the gas pressure in the gap does not increase even if the gas flow rate is increased. Thus, it is difficult to obtain the effect of introducing the gas. Therefore, it is more desired that the width of the gap 50 be 0.5 mm or less. There is no lower limit in the width of the gap 50 as long as the storage container 9 can be easily detached from the heating container 10 and the storage container 9 can be easily attached to the heating container 10. The lower limit of the width of the gap 50, for example, is 0.1 mm.

When deposition is performed in this embodiment, the gas is introduced into the gap 50 between the storage container 9 and the heating container 10 through the gas introduction tube 11 using the mass flow controller 12, while the deposition material held in the storage container 9 is heated by the heater 20 via the heating container 10. The gas present in the gap 50 allows efficient transfer of heat from the heating container 10 to the storage container 9, so that the deposition material in the storage container 9 is thermally melted and vaporized from the vaporization surface 9S, so as to be supplied onto the surface of the substrate 4.

The gas introduction amount is controlled by the mass flow controller 12 so that a vacuum gauge 40 attached to the chamber 2 indicates a constant pressure. The gas introduction amount is desirably controlled according to the pressure in the chamber 2. It is possible to suppress variation in the vaporization rate resulting from a change in the degree of vacuum by controlling the gas introduction amount so that the pressure in the chamber 2 is constant. Further, since the gas pressure in the gap 50 between the heating container 10 and the storage container 9 can be kept constant, heat conduction from the heating container 10 to the storage container 9 is made stable, and the vaporization rate from the storage container 9 is made easy to maintain.

As the gas to be introduced, it is desired to use a gas that is not reactive with the deposition material. For example, when the deposition material is lithium, an inert gas such as helium, argon, and nitrogen is desired. When oxygen is used as the gas, lithium is oxidized, which makes deposition of metal lithium impossible. Also in the case of using organic EL materials as the deposition material, the above-mentioned inert gas can be used. In the case where a thin film of an oxide of the deposition material is formed on the substrate 4, oxygen gas may be introduced into the gap 50.

On the inner bottom surface of the heating container 10, a plurality of support projections 60 are provided as shown in FIG. 2. When the storage container 9 is inserted into the concave portion of the heating container 10, the storage container 9 is supported by the support projections 60, which allows the gap 50 to be formed without contact of the outer bottom surface of the storage container 9 with the inner bottom surface of the heating container 10. The height of the projections can be adjusted according to the dimension of the gap to be formed. As another embodiment, spacers may be disposed on the inner bottom surface of the heating container 10, instead of the support projections 60. A groove that functions as the gap 50 may be formed on the inner bottom surface of the heating container 10. The gas can be introduced into the groove formed on the inner bottom surface of the heating container 10 through the gas introduction tube 11. In this case, the outer bottom surface of the storage container 9 is partially in contact with the inner bottom surface of the heating container 10.

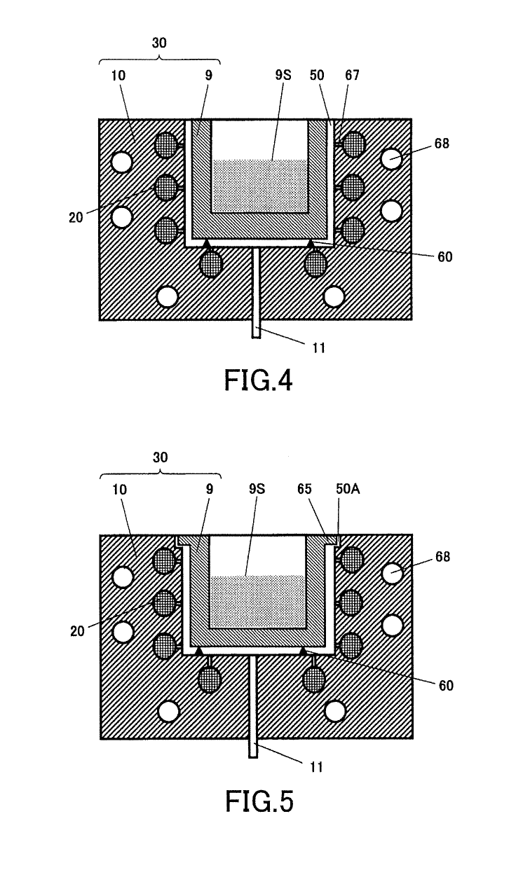

In FIG. 2, heat emitted by the heater 20 is transferred to the heating container 10 through the contact between the heater 20 and the heating container 10. Meanwhile, in another embodiment shown in FIG. 4, the space accommodating the heater 20 inside the constituent material of the heating container 10 communicates into the inner wall surface of the heating container 10 through at least one communication passage 67, in addition to the configuration of FIG. 2. Through this communication passage 67, the gas introduced into the gap 50 is introduced also into the space accommodating the heater 20. This increases the amount of heat to be conducted, so that the heat from the heater is transferred more efficiently to the storage container 9.

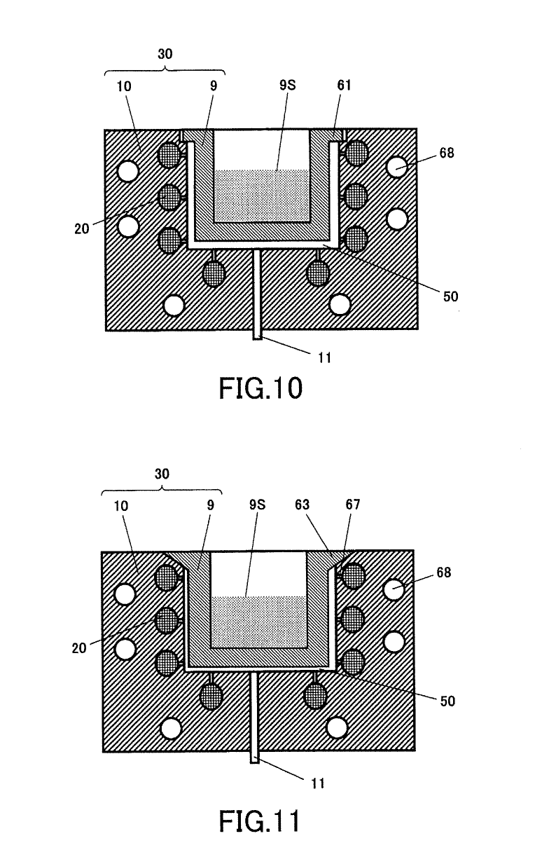

It is also possible to prevent the outer bottom surface of the storage container 9 from being in contact with the inner bottom surface of the heating container 10 by providing a step or taper around the opening of the heating container 10 and the opening of the storage container 9, as shown in FIG. 10 or FIG. 11 so as to support the storage container 9, instead of providing the projections or the spacers in FIG. 2 and FIG. 4.

In the vaporization source 30, a suppression structure that suppresses the gas from flowing out of the gap 50 into the chamber 2 may be provided. The suppression structure may be configured to change the flow direction of the gas flowing out of the gap 50, or may be configured to reduce the amount of gas flowing out of the gap 50. When such a suppression structure is provided therein, it is possible to increase the pressure in the gap 50 with a small gas introduction amount. Also, it is also possible to avoid a reduction in the degree of vacuum inside the chamber 2 from being caused by introduction of the gas into the gap 50. Some specific examples of the suppression structure are described below.

In FIG. 10, a rectangular supporting portion 61 projecting outward is provided on the outer wall surface around the opening of the storage container 9. By placing this supporting portion 61 on the upper end surface of the heating container 10 in the vertical direction, it is possible to support the storage container 9 so that the outer bottom surface of the storage container 9 is not in contact with the inner bottom surface of the heating container 10. In FIG. 10, a rectangular concave portion that corresponds to the size of the supporting portion 61 is provided on the upper end surface of the heating container 10 in the vertical direction so that positioning by the supporting portion 61 is enabled. However, the rectangular concave portion may be omitted.

In FIG. 11, a tapered supporting portion 63 projecting outward is provided on the outer wall surface around the opening of the storage container 9, and a tapered concave portion that fits the tapered supporting portion 63 is provided on the upper end surface of the heating container 10 in the vertical direction. This embodiment allows accurate positioning to be performed when the storage container 9 is accommodated into the heating container 10, so that the gap 50 as desired is ensured to be formed on the side surface and the bottom surface of the storage container 9.

In FIG. 10 and FIG. 11, since the storage container 9 is supported by a step or a taper, the gap 50 is closed between the openings of the storage container 9 and the heating container 10, thus forming a space isolated from the chamber 2. Therefore, it is possible to increase the pressure in the gap 50 with a small gas introduction amount. It is also possible to avoid a reduction in the degree of vacuum (increase in pressure) inside the chamber 2 from being caused by introduction of the gas into the gap 50. When the degree of vacuum inside the chamber 2 is reduced, film properties of the deposition film might be deteriorated due to scattering of deposition particles. Further, an excessive load might be imposed to an evacuation pump 1 (vacuum pump). The communication passage 67 in FIG. 10 and FIG. 11 can be omitted.

In another embodiment shown FIG. 3 and FIG. 5, the gap 50A around the openings is narrower than the other part of the gap 50 by providing a step at the opening of the heating container 10 and the opening of the storage container 9 as well as providing the projections 60 on the inner bottom surface of the heating container 10 so as to support the storage container 9. In this regard, a rectangular projecting portion 65 projecting outward is provided on the outer wall surface around the opening of the storage container 9. The projecting portion 65 is not in contact with the heating container 10. Since the gap 50A around the opening is narrowed, the gas introduced into the gap 50 can be suppressed from diffusing into the chamber 2, so that the pressure in the gap 50 is increased with a small gas introduction amount and a reduction in the degree of vacuum inside the chamber 2 is suppressed.

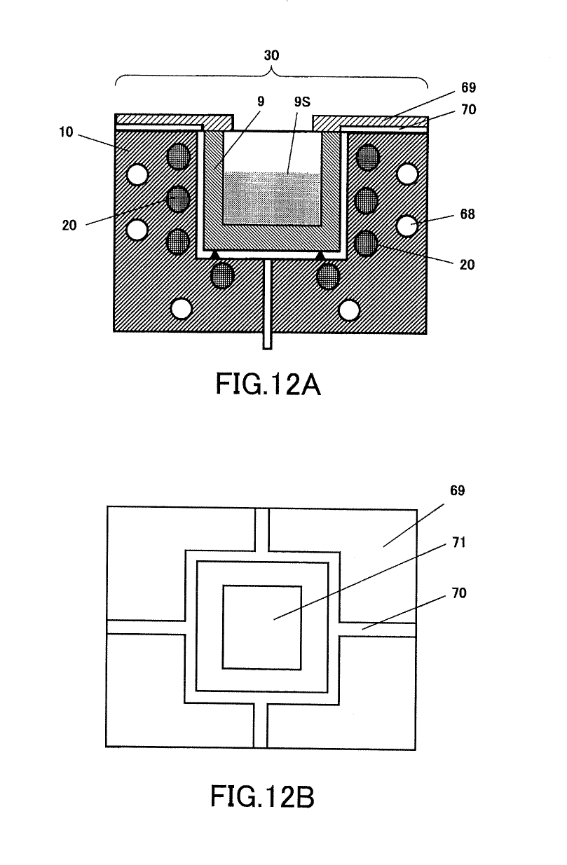

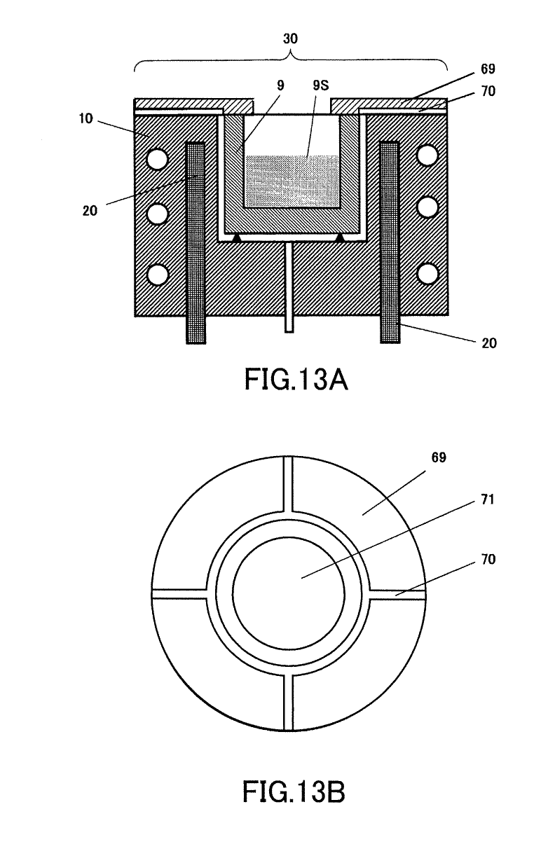

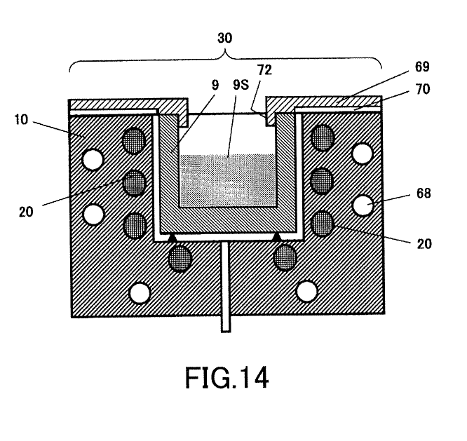

In another embodiment shown in FIG. 12A, FIG. 13A, and FIG. 14, the lid 69 is placed on the upper end surface of the heating container 10 and the upper end surface of the storage container 9 so as to close the upper opening of the gap 50. The existence of the lid 69 suppresses gas diffusion into the chamber 2, so that the pressure in the gap 50 can be increased with a small gas introduction amount and a reduction in the degree of vacuum inside the chamber 2 can be avoided. The lid 69 has a through hole 71, at its center, that corresponds to the shape of the opening of the storage container 9, so as not to inhibit the vaporization of the deposition material from the storage container 9.

FIG. 12B and FIG. 13B show the lower surface of the lid 69. As shown in these drawings, a plurality of gas flow passages 70 in the form of grooves are desirably provided on the lower surface of the lid 69. The gas flow passages 70 are formed so as to guide the gas introduced into the gap 50 to the outside of the storage container 9 (the opposite side to the opening of the storage container 9). This allows the gas introduced into the gap 50 to be discharged into the chamber 2 at a point away from the opening of the storage container 9. Accordingly, it is possible to avoid causing adverse effects on the deposition such as that the gas introduced into the gap 50 leaks in the direction of the opening of the storage container 9 to collide with the deposition material that is being vaporized from the storage container 9, resulting in deterioration in film properties (e.g., the adhesion strength to the substrate is weakened, or the film is made porous). In this way, the lid 69 may be configured to change the flow direction of the gas flowing out of the gap 50, or may be configured to reduce the amount of gas flowing out of the gap 50.

Since FIG. 12A and FIG. 13A are drawings showing the cross section including the gas flow passages 70, the lower surface of the lid 69 and the upper end surface of the heating container 10 are not in contact with each other. However, in the region other than the gas flow passages 70, the lower surface of the lid 69 and the upper end surface of the heating container 10 are directly in contact. The length and the number of the gas flow passages 70 can be set according to the gas pressure in the gap 50.

The heating container 10 and the storage container 9 each have a rectangular shape in the embodiments of FIG. 12A and FIG. 14 and a circular shape in the embodiment of FIG. 13A, as seen from their upper end surface or lower surface. In the embodiment shown in FIG. 13A, the rod-shaped heater 20 oriented in the vertical direction is embedded in the heating container 10 from below.

In FIG. 14, a flange (convex portion) 72 in a shape that corresponds to the opening of the storage container 9 is provided on the lower surface of the lid 69. This allows accurate positioning to be performed when the lid 69 is placed on the upper end surface of the heating container 10 and the upper end surface of the storage container 9, thus preventing a position of the lid 69 from shifting in the horizontal plane.

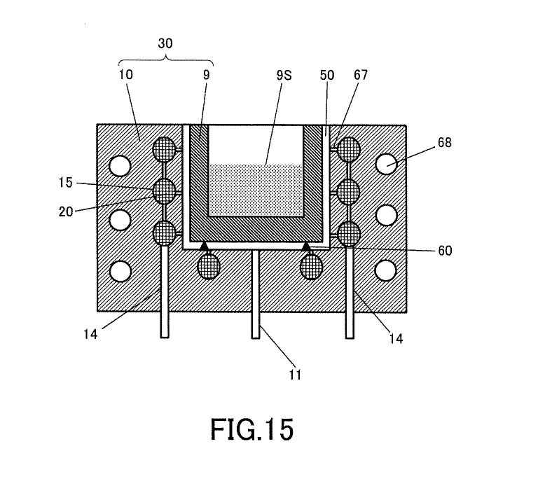

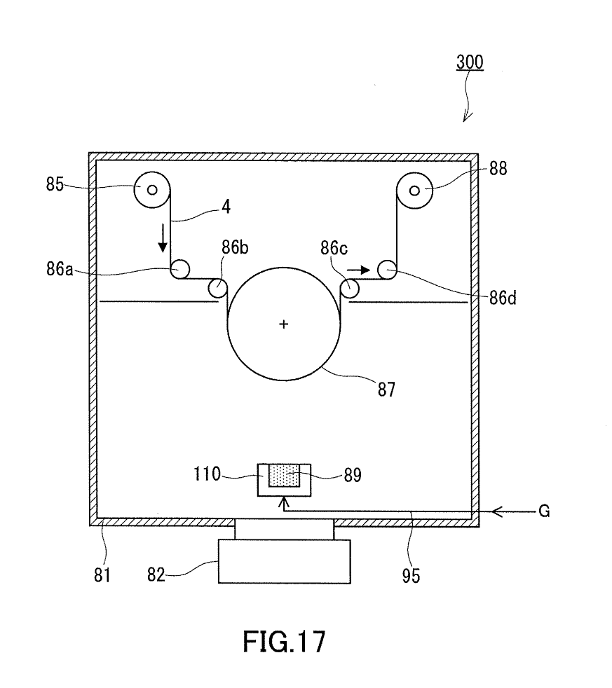

In another embodiment shown in FIG. 15, the gas is introduced directly into the periphery of the heater 20. Specifically, a long hole 15 is formed within the heating container 10. The heater 20 is detachably inserted into the hole 15. The diameter of the hole 15 is slightly larger than the diameter of the heater 20, and a gap is formed between the inner peripheral surface of the hole 15 and the outer peripheral surface of the heater 20. A gas introduction tube 14 (gas introduction channel) is connected to the hole 15 so as to introduce the gas into the gap therethrough. The gas introduced into the hole 15 through the gas introduction tube 14 is introduced also into the gap 50 through the communication passage 67. The gas introduction tube 11 that directly introduces the gas into the gap 50 may be omitted, or the gas introduction tube 11 and the gas introduction tube 14 may be used in combination. Structures of the later mentioned embodiments (FIG. 17 to FIG. 26) can be applied to the embodiment shown in FIG. 15.

As shown in FIG. 1, the conveying section includes first and second rolls 3 and 8 that hold the substrate 4 wound around themselves, and a guide section that guides the substrate 4. The guide section has conveying rollers 5a and 5b, and the cooling can 6, which define a route for conveying the substrate 4 so that the substrate 4 passes through the region (deposition region) on the cooling can 6 that the deposition material vaporized from the vaporization surface 9S reaches. A length measuring device (not shown) measures the rotation amount of a conveying roller (which herein is the conveying roller 5a) rotating to convey the substrate 4, and calculates the moving distance of the substrate 4.

For example, the first and second rolls 3 and 8, the conveying rollers 5a and 5b, and the cooling can 6 each have a cylindrical shape having a length of 600 mm and are arranged inside the chamber 2 so that their axes are parallel to one another. FIG. 1 shows only the cross section that is parallel to the bottoms of these cylindrical shapes.

In this embodiment, the substrate 4 is unwound by either one of the first and second rolls 3 and 8, then the unwound substrate 4 is guided along the conveying route by the conveying rollers 5a and 5b, and the cooling can 6, and the substrate 4 is wound up by the other one of the first and second rolls 3 and 8. The wound substrate 4 is further unwound by the other roll mentioned above and conveyed in the reverse direction along the conveying route, as needed. In this way, the first and second rolls 3 and 8 in this embodiment can function as both a unwinding roll and a winding roll depending on the conveying direction. Further, it is possible to adjust the number of times the substrate 4 passes through the deposition region by repeating the inversion of the conveying direction, thereby allowing a desired number of times of the deposition step to be performed continuously.

The shielding section 13 for shielding radiant heat is provided in the periphery of the heating container 10. Since the heating container 10 is heated to a temperature, for example, as high as about 1000° C., the shielding section 13 is provided in order to reduce the temperature rise in the deposition apparatus and the substrate in the region other than the deposition region.

### Operation of Deposition Apparatus

Next, the operation of the deposition apparatus 100 is described. The case of forming a lithium metal film on the surface of the substrate 4 using the deposition apparatus 100 is described herein as an example, which however is not restrictive.

As a first step, a step of heating a vaporization source is performed. Specifically, the elongated substrate 4 is wound onto one of the first and second rolls 3 and 8 (which herein is the first roll 3). As the substrate 4, metal foils such as aluminum foil, copper foil, and nickel foil can be used. In this embodiment, copper foil with a thickness of 25 μm is used. A deposition material (lithium metal) is held in the storage container 9. The gas introduction tube 11 is connected, for example, to an argon gas tank provided outside the deposition apparatus 100. Under this state, the chamber 2 is evacuated by the evacuation pump 1.

Subsequently, an argon gas is introduced into the gap 50 while the flow rate is being regulated by the mass flow controller 12. At this time, the flow rate is controlled so that the vacuum gauge 40 indicates an intended pressure. In this embodiment, control is performed so that the vacuum gauge 40 indicates a pressure of 5×10⁻³ Pa.

Next, a current is applied to cartridge heaters as the heater 20, so that heating of the heating container 10 is started. Since the saturated vapor pressure of lithium at 380° C. is approximately 5×10⁻³ Pa, the temperature of the heating container 10 is increased up to 380° C. As the temperature of the heating container 10 is increased, the flow rate of the argon gas is gradually reduced by the mass flow controller 12 so that the pressure of the vacuum gauge is kept constant. The temperature of the gas in the gap 50 reaches a temperature exceeding the vaporization temperature of the deposition material (lithium metal).

Next, a vaporization step is performed as a second step. That is, the temperature of the heating container 10 is further increased so that the lithium metal in the storage container 9 is vaporized at a specific vaporization rate. In this embodiment, the temperature of the heating container 10 is increased up to 600° C.

At this time, the introduction amount of argon gas is 0.5 SLM (standard liter per minute) in the case of the vaporization source 30 having the structure shown in FIG. 2, while the gas introduction amount is 0.2 SLM in the case of the vaporization source having the structure shown in FIG. 3. That is, when the gap 50A around the opening of the storage container 9 and the opening of the heating container 10 is narrowed as shown in FIG. 3, the amount of the gas that leaks from the gap 50A is small, and therefore a desired gas pressure can be achieved with a small gas introduction amount.

Further, the current value of the heater 20 is 4 A per cartridge in the case of the vaporization source 30 having the structure shown in FIG. 2, while the current value of the heater 20 is 3.4 A per cartridge in the case of the vaporization source having the structure shown in FIG. 4. That is, in the case where the communication passage 67 (through passage) that allows the gas to pass therethrough is provided between the space accommodating the heater 20 and the inner wall surface of the heating container 10 as shown in FIG. 4, heat from the heater 20 is more efficiently transferred to the storage container 9, thereby allowing a reduction in the amount of heating by the heater 20.

As a third step, a step of forming a deposition film is performed. That is, the substrate 4 wound on the first roll 3 is unwound and conveyed toward the second roll 8 via the cooling can 6. In this embodiment, the substrate 4 is conveyed at a speed of 5 m/min. The substrate 4 is subjected to deposition when passing through the deposition region, and thereafter is wound up into the second roll 8. Once a specific length has been deposited, conveyance of the substrate 4 is stopped.

As a fourth step, a step of detaching the storage container is performed. That is, after the substrate 4 with the specific length is unwound in the third step and the deposition has been completed, the current supply to the heater 20 is stopped so as to stop heating of the heating container 10. In order to shorten the cooling time, a valve 25 is opened so that compressed air is introduced into the air-cooling passage 68 through a compressed air-introducing tube 26, though it is also possible to take time as it is until the heating container 10 is cooled to room temperature. The introduced compressed air is discharged through a compressed air-discharging tube 27 while cooling the heating container 10 by passing through the air-cooling passage 68. When the temperature of the heating container 10 has been lowered to room temperature, the storage container 9 can be separated from the heating container 10 so as to be taken out therefrom. The lithium metal within the storage container 9 is allowed to be under atmospheric pressure again without reacting with moisture in the atmosphere by introducing dry air having a dew point of −40° C. into the chamber 2 after the temperature of the heating container 10 has been lowered to room temperature. In this embodiment, repetitive deposition is enabled by replacing the storage container 9, and thus the maintenance work is exceptionally simple and easy.

(Test Examples)

Tests for confirming the effect of gas introduction on the temperature rise of the storage container were conducted, using the storage container and the heating container shown in FIG. 13A.

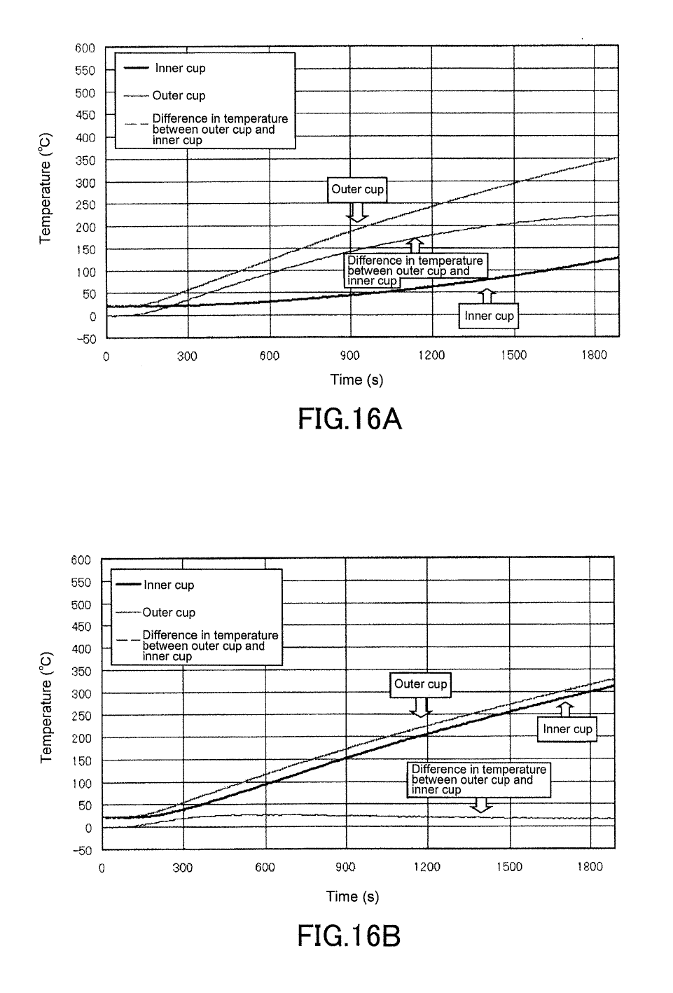

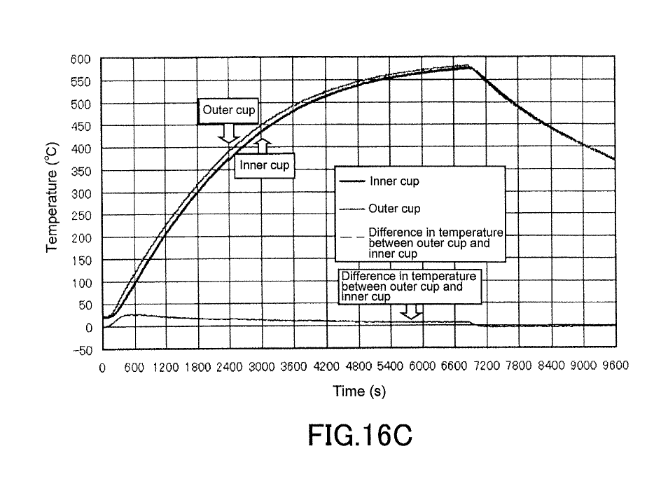

The storage container and the heating container were provided under vacuum with the storage container not holding the deposition material. While the heating container was heated, the temperature of each of the storage container and the heating container was measured over time. Further, the difference in temperature between the storage container and the heating container was calculated. FIG. 16A shows the results of measurement with no gas introduced into the gap between the storage container and the heating container (comparative test example). FIG. 16B and FIG. 16C show the results of measurement with a gas introduced thereinto (test examples).

The above-described tests were conducted under the following conditions.

Heating container (outer cup): made of SUS405; Thermal expansion coefficient: 10.8×10⁻⁶; Inner dimension of the opening in which the storage container is accommodated: 50.4 mm diameter×70.2 mm height

Storage container (inner cup): made of SUS304; Thermal expansion coefficient: 17.3×10⁻⁶; Outer dimension: 50 mm diameter×70 mm height

Heater: 8 cartridge heaters, manufactured by SAKAGUCHI E. H VOC CORP., inserted into the heating container for use; Heating conditions: AC 40 V, 6.3 A, 250 W

The vacuum chamber enclosing the storage container and the heating container was evacuated to a vacuum of 5 Pa with a vacuum pump.

As a gas to be introduced into the gap between the storage container and the heating container, nitrogen gas was used. The gas flow rate was set to 20 sccm (standard cubic centimeter per minute).

As seen from FIG. 16A, in the case where the nitrogen gas was not introduced, the temperature rise of the storage container has started after about 15 minutes from the start of the temperature rise of the heating container, which was a slow response. Further, the difference in temperature between the heating container and the storage container was significant, and the storage container was not heated sufficiently.

On the other hand, FIG. 16B shows that, in the case where nitrogen gas was introduced, the time lag in the start of the temperature rise between the heating container and storage container was 50 seconds, which was small. FIG. 16B and FIG. 16C show that the temperature of the storage container follows the temperature of the heating container, and the difference in temperature between the heating container and the storage container was small. FIG. 16C shows that, even when the temperature of the storage container has reached 575° C., the temperature of the storage container followed the temperature of the heating container.

The above results proved that it is possible to heat the storage container efficiently under vacuum by introducing a gas into the gap between the heating container and the storage container.

### Embodiment 2

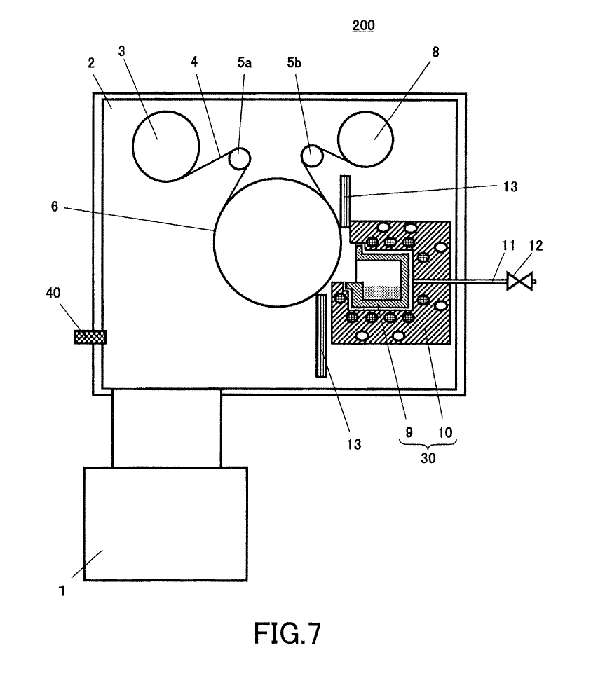

FIG. 7 is a sectional view schematically showing a deposition apparatus 200 of Embodiment 2. As is Embodiment 1, Embodiment 2 is an embodiment in which deposition is performed in a deposition region on the cooling can 6, while the substrate 4 in the form of a sheet is conveyed, within the chamber 2. However, the openings of the storage container 9 and the heating container 10 are formed on the respective side surfaces of the two containers. The cooling can 6 is disposed so as to be closely spaced to these openings formed on the side surfaces. This also allows deposition onto the substrate 4, in the same manner as in Embodiment 1.

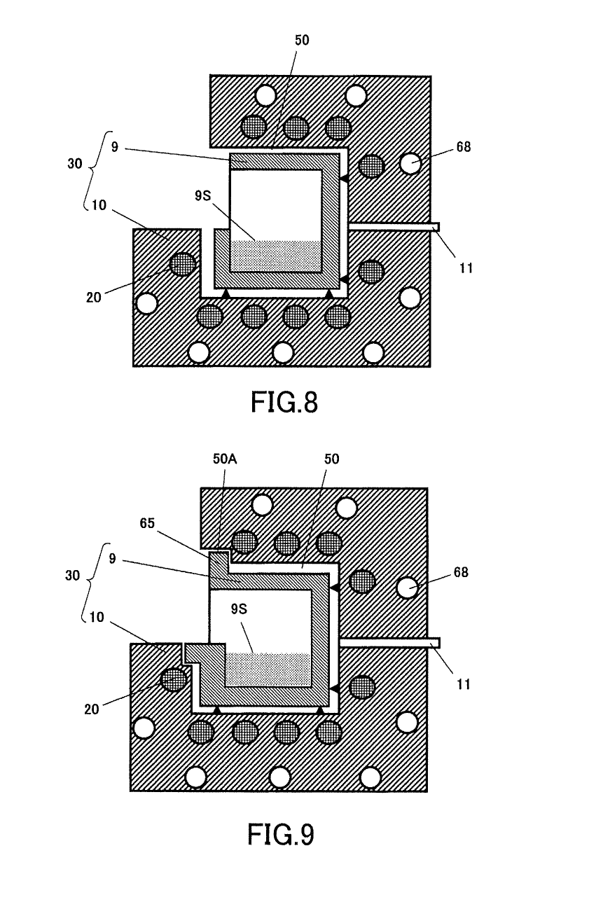

FIG. 9 is an enlarged partial view showing the vicinity of the vaporization source in the deposition apparatus of FIG. 1. Similarly to FIG. 3, the gap 50A around the openings is made narrower than the other part of the gap 50 by providing a step at the opening of the heating container 10 and the opening of the storage container 9. FIG. 8 relates to another embodiment, showing the case where such a step is not provided.

Hereinbefore, the case of deposition onto a substrate in the form of a sheet that is being conveyed along the cooling can has been described, but the present invention is not limited thereto. The deposition apparatus of the present invention can be used also for deposition onto a substrate standing still or for deposition onto a substrate in the form of a sheet that is being linearly conveyed. The substrate that is being linearly conveyed may be a substrate that is being conveyed horizontally or may be a substrate that is being conveyed obliquely.

### Embodiment 3

As shown in FIG. 17, a vacuum deposition apparatus 300 is provided with a vacuum chamber 81, a vacuum pump 82, an unwinding roll 85, conveying rollers 86a to 86d, a can roller 87, a winding roll 88, and a vaporization source 110. The vaporization source 110 is disposed at a position facing the can roller 87. The substrate 4 is prepared on the unwinding roll 85 and is fed to the conveying roller 86a. The substrate 4 is further conveyed along the conveying roller 86b, the can roller 87, the conveying roller 86c, and the conveying roller 86d, and then is wound up into the winding roll 88. The unwinding roll 85, the conveying rollers 86a to 86d, the can roller 87, and the winding roll 88 form a conveying system for conveying the substrate 4.

When the substrate 4 is conveyed along the outer peripheral surface of the can roller 87, a material 89 vaporized from the vaporization source 110 is deposited onto the substrate 4. This allows a thin film containing the material 89 to be formed on the substrate 4. During deposition, the pressure in the vacuum chamber 81 is maintained, by the function of the vacuum pump 82, at a pressure suitable for producing a thin film. The degree of vacuum in the vacuum chamber 81 is not specifically limited, and is in the range of 10⁻¹ to 10⁻⁴ Pa, for example.

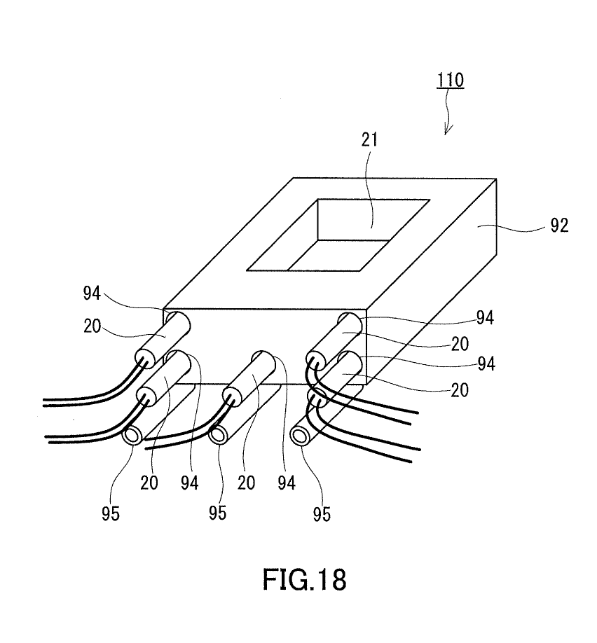

As shown in FIG. 18 to FIG. 20, the vaporization source 110 is provided with a heating block 92 and a plurality of rod-shaped heaters 20, and is configured as a heating apparatus (heating unit) that heats a substance (material 89) under vacuum. The heating block 92 is a vaporization container (crucible) having a concave portion 21 that holds the material 89 to be vaporized. The heating block 92 is heated by application of a current to the heaters 20. The heaters 20 heat the heating block 92, thereby causing the material 89 held in the concave portion 21 to be melted and vaporized.

In the heating block 92, a plurality of slots 94 and a plurality of gas introduction channels 97 are formed. The slots 94 are each a long hole capable of accommodating each heater 20. In the periphery of the concave portion 21, each slot 94 extends in a direction parallel to one side of the heating block 92 (typically in the horizontal direction), passing through the heating block 92 from one side surface to the other side surface. The slot 94 does not necessarily pass through the heating block 92. The slot 94 may be a bottomed hole. The heater 20 is detachably inserted into the slot 94. The gas introduction channels 97 are each a channel for introducing the heat transfer gas into a gap 96 between the slot 94 and the heater 20. In this embodiment, each gas introduction channel 97 is open at the bottom 92p of the heating block 92, and in communication with the slot 94 inside the heating block 92. Gas supply tubes 95 are each connected to the bottom 92p of the heating block 92 so as to supply the heat transfer gas to the gas introduction channel 97. As shown in FIG. 17, each gas supply tube 95 extends from the heating block 92 to the outside of the vacuum chamber 81.

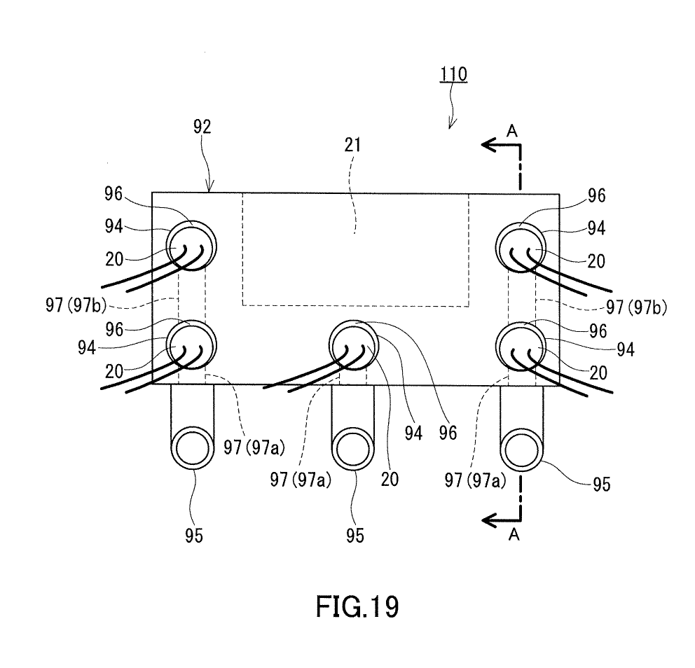

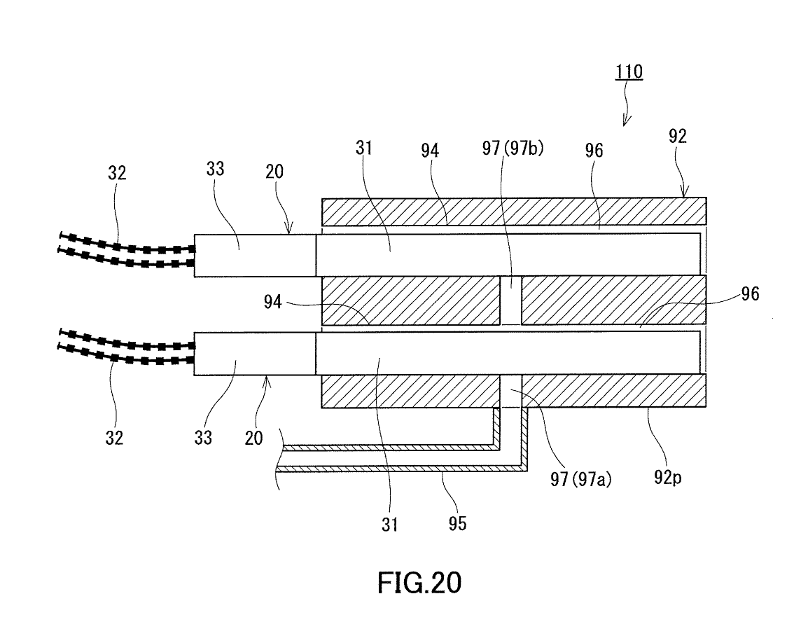

As shown in FIG. 19 and FIG. 20, each heater 20 has a smaller outer diameter than the inner diameter of each slot 94. Therefore, the heater 20 is in contact with the lower half of the slot 94. This allows the gap 96 to be formed above the heater 20. When the heat transfer gas is supplied to the gas introduction channels 97 through the gas supply tubes 95, the heat transfer gas is introduced into the gaps 96 through the gas introduction channels 97. The gaps 96 are filled with the heat transfer gas, thereby allowing heat to be efficiently transferred from the heaters 20 to the heating block 92 despite being under vacuum.

In the vacuum deposition apparatus 300 shown in FIG. 17, the material 89 of a thin film is vaporized under vacuum using the vaporization source 110, and the material 89 thus vaporized is deposited onto the substrate 4 (deposition step or heating step). While the deposition step is performed, the heat transfer gas is supplied from outside the vacuum chamber 81 to the gas introduction channels 97 of the vaporization source 110 through the gas supply tubes 95 so that the gaps 96 are filled with the heat transfer gas.

The type of the heat transfer gas is not specifically limited. However, in the case of applying the present invention to the vaporization source 110, use of gases such as a gas that reacts readily with the material to be deposited and a gas that inhibits the production of thin films of high quality should be avoided. From such a viewpoint, an inert gas, particularly a rare gas such as argon, can be used suitably as the heat transfer gas.

A plurality of slots 94 are formed in the heating block 92. The heaters 20 are inserted respectively into the plurality of slots 94. The plurality of heaters 20 are disposed in a manner as to surround the concave portion 21. With such a configuration, it is possible to heat the heating block 92 uniformly, so as to heat the material 89 held in the concave portion 21 uniformly. In this regard, the number of the heaters 20, the slots 94, and the gas introduction channels 97 is not specifically limited.

As shown in FIG. 19 and FIG. 20, each gas introduction channel 97 includes a first channel 97a and a second channel 97b. The first channel 97a is a channel that introduces the heat transfer gas from outside the heating block 92 into a specific one of the slots 94. The second channel 97b is a channel that allows the slots 94 to communicate with each other. According to this configuration, the number of the gas supply tubes 95 may be smaller than the number of the slots 94. This contributes to making the structure of the heating block 92 simple. The heat transfer gas is supplied to the first channel 97a of the gas introduction channel 97 through one of the gas supply tubes 95, and then is introduced into the gap 96 in a specific one of the slots 94 through the first channel 97a. The heat transfer gas is further introduced into the gap 96 in another one of the slots 94 through the second channel 97b. Accordingly, it is possible to promote the heat transfer from the heaters 20 to the heating block 92 with a small amount of the heat transfer gas.

The vaporization source 110 may be designed so that the conductance of the second channel 97b exceeds the leakage conductance of the channel that extends from the gap 96 to the space inside the vacuum chamber 81. In this case, it is easy to distribute just the right amount of the heat transfer gas to each of the plurality of gaps 96, as well as dissipation of the heat transfer gas into the vacuum chamber 81 can be reduced.

Further, the outer diameter of the heater 20 and the inner diameter of the slot 94 are suitably adjusted so that the heater 20 can be pulled out easily from the slot 94 and the heater 20 can be inserted easily into the slot 94, even after the vaporization source 110 is repeatedly used. For example, the inner diameter of the slot 94 can be set so that, when the outer diameter of the heater 20 is in the range of 5 to 15 mm, the value obtained by subtracting the outer diameter of the heater 20 from the inner diameter of the slot 94 (that is, the width of the gap 96) should fall within the range of 0.05 to 0.5 mm. When the difference between the outer diameter of the heater 20 and the inner diameter of the slot 94 falls within such a range, the vacuum can be maintained without imposing excessive load on the vacuum pump 82.

Further, the size of the heater 20 and the size of the slot 94 may be adjusted so as to allow the motion of the heater 20 during energization. Specifically, the difference between the outer diameter of the heater 20 and the inner diameter of the slot 94 can be adjusted. The difference between the outer diameter and the inner diameter can be calculated from the linear expansion coefficient of the material of the heater 20, the linear expansion coefficient of the material of the heating block 92, and the use temperature of the heater 20. Further, it is desired that no compression is applied to the heater 20 in the slot 94 and a fixing member such as a screw is not used to fix the heater 20 to the heating block 92. With such a configuration, application of a large force (load or stress) to the heater 20 can be prevented from being caused by thermal expansion during energization. Therefore, the life of the heater 20 is extended. During energization, the load applied to the heater 20 may be substantially zero except the supporting force applied from the inner peripheral surface of the slot 94.

The heating block 92 is made of a heat-resistant material such as stainless steel, copper, and carbon. In this embodiment, the heating block 92 has a square-box shape. However, the shape, size, etc., of the heating block 92 are not specifically limited.

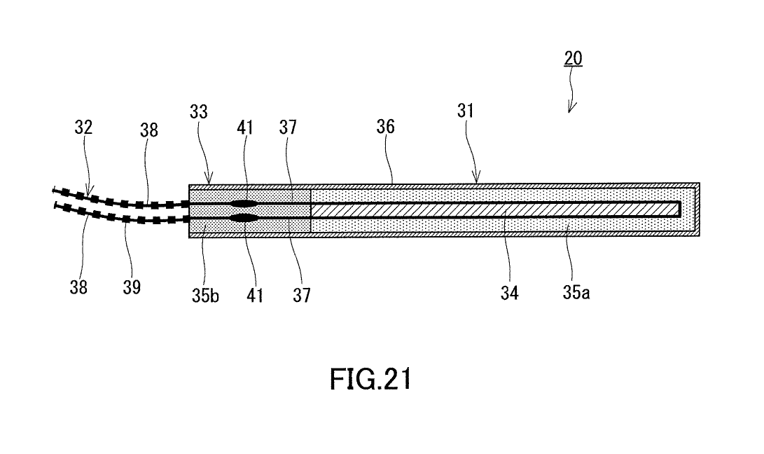

As shown in FIG. 21, the heater 20 is constituted by a heater main body 31, a lead section 32, and a connecting section 33. The cross sectional shape of the heater 20 is not specifically limited, and typically is a circular shape, or may be an elliptical or rectangular shape. That is, the heater 20 may be circular cylindrical, elliptical cylindrical, or rectangular cylindrical in shape. Also the cross sectional shape of the slot 94 is not specifically limited, and typically is a circular shape, or may be an elliptical or rectangular shape.

The heater main body 31 is connected to the lead section 32 via the connecting section 33. The heater main body 31 has a heating element 34, an insulator 35a, and an outer cylinder 36. The lead section 32 has a pair of lead wires 38 and insulation coatings 39. The connecting section 33 has an insulator 35b, the outer cylinder 36, and a pair of heater wire end portions 37. The connecting section 33 is provided between the lead section 32 and the heater main body 31 so that the lead wires 38 are electrically connected to the heating element 34. Electric power is supplied to the heating element 34 through the lead wires 38. The outer cylinder 36 may be shared by the heater main body 31 and the connecting section 33.

The heating element 34 is formed, for example, by winding a wire of metal such as tungsten, and is covered by the outer cylinder 36. The insulator 35a is filled between the heating element 34 and the outer cylinder 36. The insulation coatings 39 are provided so as to cover the lead wires 38. The insulation coatings 39 are made of glass fiber, ceramic, or the like. The lead wires 38 are connected respectively to the heater wire end portions 37 at connection points 41 of the connecting section 33. A power applying section is formed of the lead wires 38, the heater wire end portions 37, and the connection points 41 in the connecting section 33. The insulator 35b is filled between the power applying section and the outer cylinder 36.

As long as the power applying section is insulated, the connecting section 33 does not necessarily have the outer cylinder 36 and the insulator 35b. However, when the outer cylinder 36 and the insulator 35b are provided in the connecting section 33, mechanical robustness in the vicinity of the connection points 41 can be enhanced. Therefore, wire breakage due to concentration of stresses can be prevented. Also, when the outer cylinder 36 in the connecting section 33 has the same outer diameter as the outer diameter of the outer cylinder 36 in the heater main body 31, handling of the heater 20 is made easy.

As shown in FIG. 20, in order to prevent excessively high temperature of the connection points 41 and the lead wires 38, the connecting section 33 is desirably located outside the slot 94. This can extend the life of the heater 20. It should be noted that the heater 20 shown in FIG. 21 is merely an example. In the present invention, the type of heater is not specifically limited.

Hereinafter, heating apparatuses according to modifications are described. In the following modifications, the same components as the components of the vaporization source 110 (heating apparatus) that have been described with reference to FIG. 17 to FIG. 21 are denoted by the same reference numerals, and descriptions thereof are omitted.

(Modification 1)

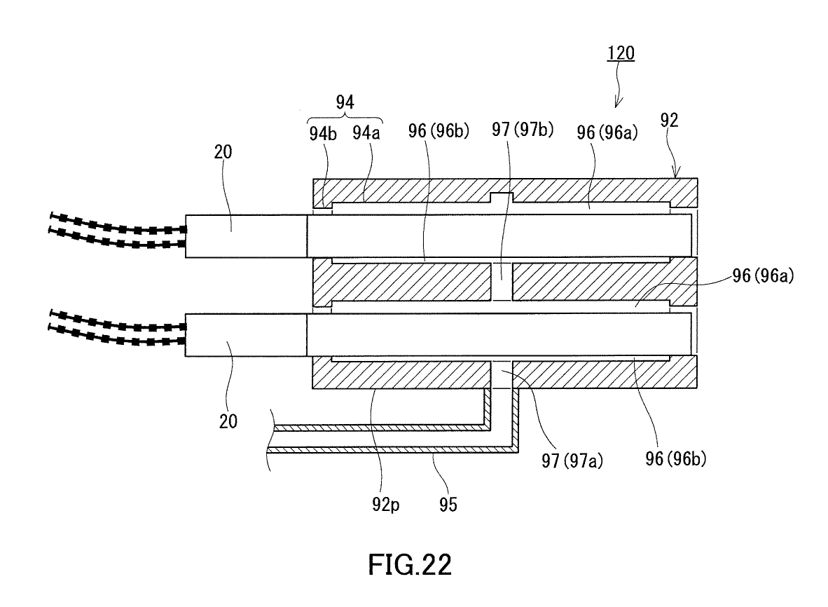

As shown in FIG. 22, the slot 94 has a center portion 94a of larger diameter and an end portion 94b of smaller diameter along the length direction in a vaporization source 120 according to Modification 1. The vaporization source 120 according to Modification 1 is different from the above-described vaporization source 110 at this point.

The center portion 94a of the slot 94 is a portion communicating with the gas introduction channel 97 (first portion 97a or second portion 97b). The end portion 94b of the slot 94 is a portion that includes the opening of the slot 94. The heater 20 has a smaller outer diameter than the inner diameter of the slot 94 in the end portion 94b. According to such the slot 94, the gap 96 is relatively wide in the center portion 94a of the slot 94, and the gap 96 is relatively narrow in the end portion 94b of the slot 94. Further, the center of the center portion 94a coincides with the center of the end portion 94b in the slot 94. Accordingly, an upper gap 96a is formed above the heater 20, and a lower gap 96b is formed below the heater 20.

In order to maintain the heat transfer gas within the gap 96, it is effective to reduce the inner diameter of the slot 94 as much as possible. However, when the inner diameter of the slot 94 is reduced excessively, it becomes difficult to insert the heater 20 thereinto and pull it out therefrom. In contrast, the gap 96 is relatively narrow in the end portion 94b of the slot 94 according to this modification, and therefore leakage of the heat transfer gas from the gap 96 can be reduced. Further, the gap 96 is relatively wide in the center portion 94a of the slot 94, so that the heater 20 can be easily inserted into the slot 94, as well as the heater 20 can be easily pulled out of the slot 94.

(Modification 2)

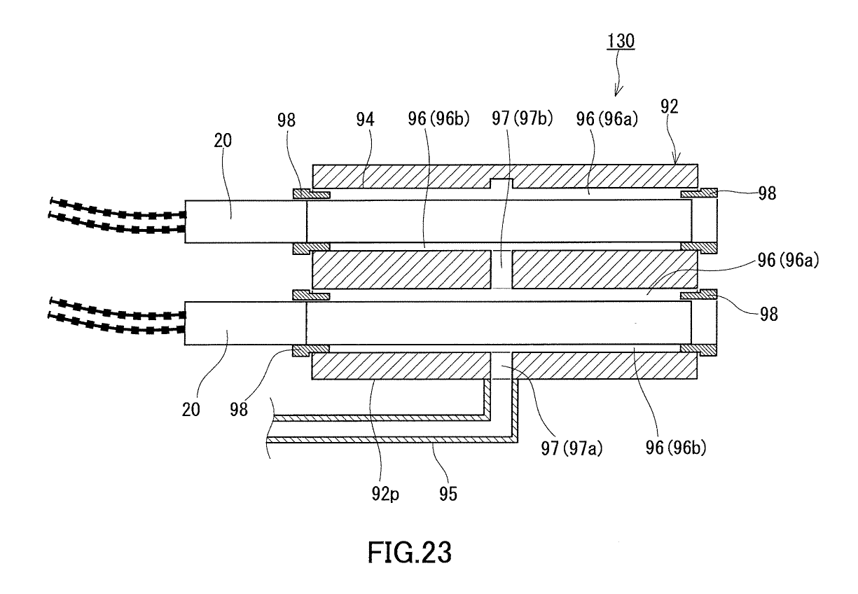

As shown in FIG. 23, a vaporization source 130 according to Modification 2 is different from the above-described vaporization source 110 in that it is further provided with a cylindrical component 98.

As shown in FIG. 23, the cylindrical component 98 is provided at the opening of the slot 94 so as to narrow the gap 96. The heater 20 is inserted into the slot 94 through the cylindrical component 98. In the same manner as in Modification 1, the upper gap 96a is formed above the heater 20, and the lower gap 96b is formed below the heater 20. The cylindrical component 98 functions as if the inner diameter of the slot 94 were reduced. Use of this cylindrical component 98 facilitates the forming processing of the slot 94 within the heating block 92.

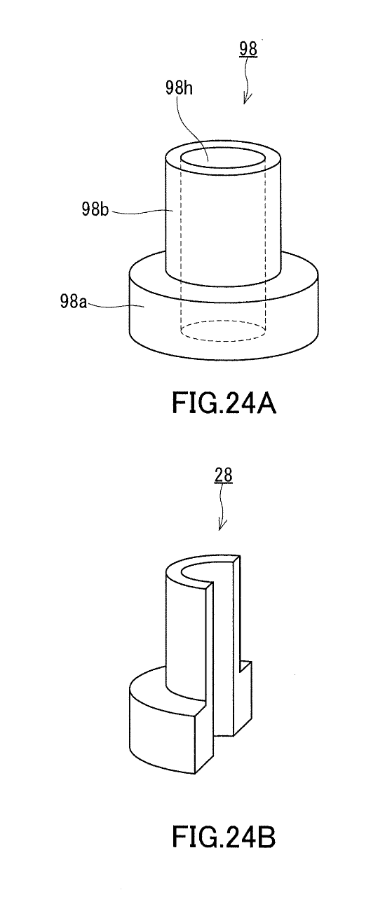

As shown in FIG. 24A, the cylindrical component 98 has a large-diameter portion 98a, a small-diameter portion 98b, and a through hole 98h. The large-diameter portion 98a is a portion having a larger outer diameter than the inner diameter of the slot 94. The small-diameter portion 98b is a portion having a smaller outer diameter than the inner diameter of the slot 94. The large-diameter portion 98a and the small-diameter portion 98b are integrated into one member. The through hole 98h is formed by penetrating through the large-diameter portion 98a and the small-diameter portion 98b. The through hole 98h has a larger inner diameter than the outer diameter of the heater 20. According to the cylindrical component 98 with such a structure, it is possible to narrow the gap 96 in the end portion of the slot 94.

Instead of the cylindrical component 98 shown in FIG. 24A, a gutter-shaped component 28 shown in FIG. 24B may be used. The gutter-shaped component 28 can be obtained by bisecting the cylindrical component 98 by the plane including the central axis of the through hole 98h. The gutter-shaped component 28 may be interposed between the heater 20 and the slot 94 at the opening of the slot 94 on the side where the lead section 32 is provided. This allows the heater 20 to be easily pulled out of the slot 94, even if the difference between the curvature radius of the inner peripheral surface of the gutter-shaped component 28 and the outer diameter of the heater 20 is small to some extent.

(Modification 3)

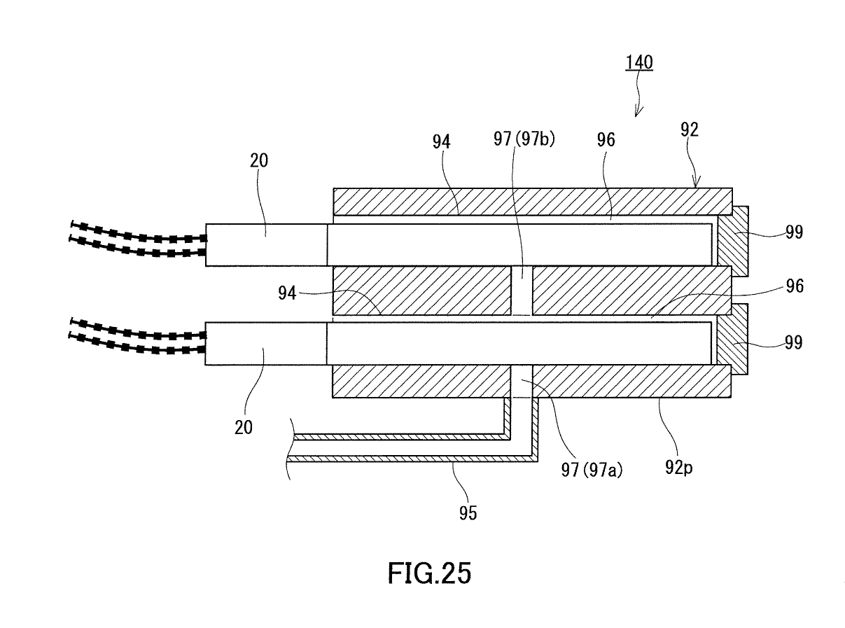

As shown in FIG. 25, a vaporization source 140 according to Modification 3 is different from the above-described vaporization source 110 in that it is further provided with a flange 99 for closing the slot 94.

Among the two openings of the slot 94, the flange 99 is disposed over the opening on the side opposite to the side where the lead wires 38 of the heater 20 are located. The slot 94 is closed by the flange 99. It is possible to reduce the amount of the heat transfer gas that leaks from the gap 96 into the vacuum chamber 81, by closing the slot 94. The flange 99 brings about the same effect as is the case where the slot 94 is formed of a bottomed hole.

The flange 99 is not necessarily provided at each of the plurality of slots 94. For example, a plate member of such a size as to cover the plurality of slots 94 collectively can be used as the flange. Further, the flange 99 may be merely inserted into the heating block 92, may be screwed thereinto, or may be welded to the heating block 92. In this way, the method for closing the slot 94 is not specifically limited.

### Embodiment 4

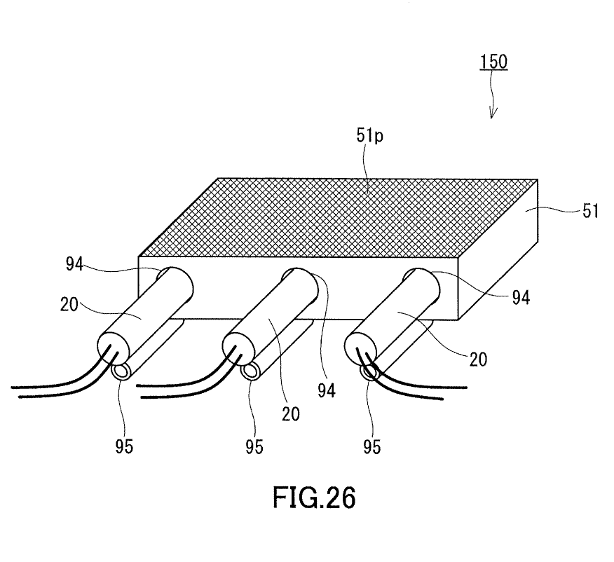

The present invention can be applied to heating apparatuses other than vaporization sources. As shown in FIG. 26, such a heating apparatus may be a substrate heating apparatus 150 that heats a substrate. The substrate heating apparatus 150 is provided with a heating block 51, a plurality of slots 94, and a plurality of heaters 20. The plurality of slots 94 and a plurality of gas introduction channels (not shown) are formed within the heating block 51. The heaters 20 are respectively inserted into the slots 94. The gas supply tubes 95 are connected to the gas introduction channels. The heating block 51 is entirely heated by application of a current to the heaters 20.

The heating block 51 is made, for example, of a heat-resistant material that can be used for the heating block 92 of the vaporization source 110. The upper surface 51p of the heating block 51 is a surface facing the substrate. The substrate can be heated by bringing the substrate close to or into contact with the upper surface 51p. The upper surface 51p may be subjected to treatment for enhancing the efficiency of heating the substrate. Examples of such treatment include formation of a black coating for enhancing the emissivity on the upper surface 51p.

The heating block 51 has almost the same structure as the structure of the aforementioned heating block 92, except that it does not have a concave portion for holding a material. That is, all the configurations described for the vaporization sources 110, 120, 130, and 140 can be advantageously applied also to the substrate heating apparatus 150. Also, the present invention can be applied to heating apparatuses that have moving parts such as a heating roller that conveys a substrate while heating the substrate.

### INDUSTRIAL APPLICABILITY

The heating apparatus of the present invention can be used for various vacuum apparatuses such as a vacuum film-forming apparatus, a vacuum processing apparatus, a vacuum metallurgical apparatus, a vacuum chemical apparatus, a surface analyzer, and a vacuum test apparatus.

1-25. (canceled)

26. A heating apparatus comprising:
an object to be heated under vacuum;
a heating body separable from the object to be heated, the heating body being configured so that a gap is formed between the heating body itself and the object to be heated; and
a gas introduction channel for introducing a heat transfer gas into the gap, wherein
the object to be heated is a heating block that heats a substance under vacuum,
the heating body is a rod-shaped heater that is detachably inserted into a slot formed within the heating block,
the gap is formed between the slot and the heater,
the gas introduction channel is formed within the heating block so as to introduce the heat transfer gas into the gap, and
the heating block is heated by the heater via the heat transfer gas.

27. The heating apparatus according to claim 26, wherein
the substance to be heated by the heating block is a storage container that holds a deposition material and that has an opening for allowing the deposition material that has been vaporized to pass therethrough,
the heating block is a heating container that detachably accommodates the storage container and that is configured to heat the deposition material in the storage container, the heating container having an opening for allowing the deposition material that has been vaporized from the storage container to pass therethrough, the heating container being configured, when accommodating the storage container, so that an inner wall surface of the heating container and an outer wall surface of the storage container directly face each other so as to form an other gap between the inner wall surface and the outer wall surface,
the heat transfer gas is introduced into the other gap through the gas introduction channel or another gas introduction channel so that the storage container is heated by the heating block via the heat transfer gas, and
the heating apparatus is a deposition apparatus and further comprises: (i) a vacuum chamber in which the storage container and the heating container are enclosed and deposition on a substrate is performed, and (ii) a vacuum pump that evacuates the vacuum chamber.

28. The heating apparatus according to claim 27, wherein
the other gap has a width of 0.5 mm or less.

29. The heating apparatus according to claim 27, further comprising:
a suppression structure that suppresses the heat transfer gas from flowing out of the other gap into the vacuum chamber.

30. The heating apparatus according to claim 29, wherein
the suppression structure is configured to change a flow direction of the heat transfer gas flowing out of the other gap, or to reduce an amount of the heat transfer gas flowing out of the other gap.

31. The heating apparatus according to claim 29, wherein
the suppression structure is a step structure or a tapered structure provided around the opening of the storage container and the opening of the heating container.

32. The heating apparatus according to claim 31, wherein
the other gap around the opening of the storage container and the opening of the heating container is narrower than the other gap other than around the openings by providing the step structure or the tapered structure.

33. The heating apparatus according to claim 27, wherein
a thermal expansion coefficient of the heating container is smaller than a thermal expansion coefficient of the storage container.

34. The heating apparatus according to claim 27, further comprising:
a through passage for allowing the heat transfer gas to pass therethrough, the through passage being provided between a space accommodating the heater inside the heating container and an inner wall surface of the heating container.

35. The heating apparatus according to claim 27, wherein
the other gap is closed at the opening of the storage container and the opening of the heating container.

36. The heating apparatus according to claim 27, wherein
a lid is placed over an opening of the other gap.

37. The heating apparatus according to claim 36, wherein
a gas flow passage that allows the heat transfer gas that has been introduced into the other gap to pass therethrough is formed on a lower surface of the lid.

38. A thin film production method being a deposition method for deposition on the substrate under vacuum using the heating apparatus according to claim 27 as a deposition apparatus,
the thin film production method comprising the step of vaporizing the deposition material from the storage container by heating the deposition material in the storage container using the heater, while introducing the heat transfer gas into the gap and the other gap.

39. The thin film production method according to claim 38, wherein
an introduction amount of the heat transfer gas is controlled according to the pressure in the vacuum chamber.

40. The thin film production method according to claim 38, wherein
the deposition material is lithium, and
the heat transfer gas is an inert gas.

41. The heating apparatus according to claim 26, wherein
a plurality of the slots are formed within the heating block,
the heater is inserted into each of the plurality of slots, and
the gas introduction channel includes a first channel that introduces the heat transfer gas from outside the heating block into the slot and a second channel that allows the slots to communicate with each other.

42. The heating apparatus according to claim 26, wherein
the gap is relatively wide in a center portion of the slot in a length direction, and
the gap is relatively narrow in an end portion of the slot in a length direction.

43. The heating apparatus according to claim 26, wherein
the heater comprises: a heater main body that has a heating element; and a lead wire that is electrically connected to the heating element of the heater main body so as to supply power to the heating element, and
the slot is closed on a side opposite to a side where the lead wire is located.

44. The heating apparatus according to claim 26, wherein
a size of the heater and a size of the slot are adjusted so as to allow motion of the heater during energization.

45. The heating apparatus according to claim 26, wherein
the heater comprises: a heater main body that has a heating element; a lead section that has a lead wire for supplying power to the heating element; and a connecting section provided between the lead section and the heater main body so as to electrically connect the lead wire to the heating element, and
the connecting section is located outside the slot.

46. The heating apparatus according to claim 26, wherein
the heating apparatus is a vaporization source, and
the heating block is a vaporization container having a concave portion that holds the substance as a material to be vaporized.

47. The heating apparatus according to claim 26, wherein
the heating apparatus is a substrate heating apparatus that heats a substrate.

48. A vacuum heating method comprising the steps of:
heating the substance under vacuum using the heating apparatus according to claim 26; and
supplying the heat transfer gas from outside vacuum to the heating apparatus while performing the heating step.

49. A thin film production method comprising the steps of:
vaporizing a material of a thin film as the substance under vacuum using the heating apparatus according to claim 26 and depositing the vaporized material on a substrate; and
supplying the heat transfer gas from outside vacuum to the heating apparatus while performing the deposition step.
